(19) United States
(12) Patent Application Publication
(10) Pub. No.: US 2025/0005755 A1
(43) Pub. Date: Jan. 2, 2025

(54) DETERMINING REAL-WORLD SIZES OF INTRAORAL FEATURES IN 2D IMAGES OF PATIENT DENTITION

(71) Applicant: Align Technology, Inc., San Jose, CA (US)

(72) Inventors: Yun GAO, Cary, NC (US); Guotu LI, Apex, NC (US); Chao SHI, Morrisville, NC (US); Christopher E. CRAMER, Durham, NC (US)

(21) Appl. No.: 18/759,623

(22) Filed: Jun. 28, 2024

Related U.S. Application Data
(60) Provisional application No. 63/511,635, filed on Jun. 30, 2023.

(51) Int. Cl. G06T 7/00; G06T 19/20

(52) U.S. Cl. CPC G06T 7/0012; G06T 19/20; G06T 2207/30036

(57) ABSTRACT

Apparatuses and methods for dental image analysis including determining pixel sizes of an image. A pixel size enables conversion of a two-dimension image-based measurement into a 3D measurement. The pixel sizes vary over the image due to differences in distance between the camera taking the image and the object of interest. A three-dimensional model may be registering to the two-dimension image, and the pixel sizes may be identified on a per-object (e.g., per-tooth) basis, per-region basis or at each point in the image. The pixel size scaling may be used to identify features in the image for diagnostic or other dental application purposes.

### CLAIM OF PRIORITY

This patent application claims priority to U.S. Provisional Patent Application No. 63/511,635, titled “PIXEL SIZE ESTIMATION,” and filed on Jun. 30, 2023, herein incorporated by reference in its entirety.

### INCORPORATION BY REFERENCE

All publications and patent applications mentioned in this specification are herein incorporated by reference in their entirety to the same extent as if each individual publication or patent application was specifically and individually indicated to be incorporated by reference.

### BACKGROUND

Orthodontic and dental treatments using a series of patient-removable appliances (e.g., “aligners”) have been found to be very useful in treating patients' teeth. Treatment planning is typically performed in conjunction with the dental professional (e.g., dentist, orthodontist, dental technician, etc.) by generating a model of the patient's teeth in a final configuration and then dividing the treatment plan into a number of intermediate stages (steps) corresponding to individual appliances that are worn sequentially. This process may be interactive, adjusting the staging and in some cases the final target position, based on constraints on the movement of the teeth and the dental professional's preferences. Once the final treatment plan is finalized, the series of aligners may be manufactured corresponding to the treatment plan.

Treatment planning and monitoring requires the collection and processing of images of the patient's teeth. For example, during orthodontic treatment, the dental professional periodically checks to make sure that the patient's teeth are moving and responding correctly according to the treatment plan. This involves obtaining two-dimensional (2D) images of the patient's teeth at their current (e.g., mid-treatment) positions and comparing these 2D images with images or models of the teeth in their expected positions at that point of treatment. If the current teeth positions are significantly off track from the expected positions according to the treatment plan, the dental practitioner may decide to have the patient repeat previous treatment steps or to modify the treatment plan altogether. Such assessments may involve determining very small (millimeter scale) differences in the current teeth positions versus expected teeth positions. Current image analysis techniques are not reliably able to resolve such small differences.

What is needed are methods and apparatuses (including software) that can be used to measure very small differences in images of a patient's teeth, in order to better assess the condition of the patient's teeth and improve patient treatment and outcomes.

### SUMMARY OF THE DISCLOSURE

The present disclosure generally relates to the estimation of pixel sizes in relation to image analysis and processing. More particularly, the present disclosure is related to systems, methods, computing device readable media, and devices for more accurately and quickly estimating pixel sizes for dental images used in dental treatment, monitoring, and planning. For example, described herein are methods and apparatuses that provide a framework for accurately estimating pixel sizes of digital images. The estimated pixel sizes may be used as conversion factors for converting pixels (of an image) to real-world measurements (e.g., micrometers, millimeters, etc.), thereby allowing for improved resolution of features in the image compared to conventional image analysis approaches. The methods may involve registering a three-dimensional (3D) model to a two dimensional (2D) image, and estimating pixel sizes in the 2D image on a per-object and/or per-region basis or as a field of different pixel sizes. The estimated pixel sizes may be mapped to points on the 2D image to generate an adjusted (e.g., scaled) 2D image. In any of these methods, the mapping may correct for possible distortions due to the orientation of the camera relative to the object or region, including determining a correction ratio that accounts for camera orientation.

The methods and apparatuses described herein provide a technical solution to the technical problem of taking accurate measurements, particularly for very small dimensions, from one or more images of a subject's teeth and/or oral cavity. In particular, these methods and apparatuses allow for very precise and rapid scaling of pixel size to actual dimensions, even across multiple images taken at a variety of different locations and orientations. Prior attempts to scale images of patient dentition are less accurate, particularly where parts of the teeth or other intraoral features are partially or fully blocked, for example, if the gingival line is obscured by the lips, if all or some of the teeth are not visible, etc.

In contrast, the methods and apparatuses described herein are well suited for use in the analysis of dental images. For example, the techniques described herein may be used to resolve features in 2D images of a patient's teeth in millimeter (mm) or sub-millimeter (e.g., micrometer) scale. The techniques may be used to analyze 2D image(s) of a patient's the teeth and/or gums as part of any of a number of evaluation and/or diagnostic procedures. These techniques may be used to determine whether a patient's teeth are on-track or off-track according to a prescribed treatment plan based on one or more 2D images of the patient's teeth. In some cases, the analysis techniques may be used to determine whether a patient has an overbite or underbite, and/or the extent of the overbite or underbite. In some cases, the analysis techniques may be used to evaluate the fit of an aligner on a patient's teeth. In some cases, the analysis techniques may be used to identify features in 2D image(s) indicative of a dental condition, such as tooth decay, tooth erosion, cracked or chipped teeth, missing teeth, gum disease, and/or other dental conditions.

The 2D images used for these methods and apparatuses do not need to be taken using a specialized camera, for example, in a dental office. For example, the 2D image(s) may be taken by the patient using a smart phone camera or other hand-held camera. This provides flexibility for the patient and saves time since the patient may collect image(s) without visiting a dental office. The patient may then send the image(s) to the dental practitioner, who can use the image analysis techniques described herein to provide accurate information regarding the patient's current teeth status.

The methods and systems described herein may be used to analyze any of a number of types of images. For example, the methods and systems may be configured to analyze one or more of a digital photographic image, an x-ray image (e.g., cone beam computed tomography (CBDT image)), a visible light image, an infrared (e.g., near infrared) image, a panoramic image (e.g., from a dental scan), a video image, a stitched image based on two or more individual images, or a combination thereof.

In general, these methods and apparatuses may be used in conjunction with intraoral scan data that was taken at an earlier date, even in cases where the patient's teeth have changed, including changing position either naturally or due to orthodontic intervention. Intraoral scan data may be processed (or may have already been processed) into a digital model of the patient's dentition, which may be used as described herein to rapidly and accurately provide highly accurate (e.g., sub-mm) pixel size scaling information.

The methods described herein provide a number of advantages over previous image analysis methods. For example, the systematic methods can be used to estimate pixel size with a much higher accuracy and robustness than previous methods. In addition, the methods have low processor and memory requirements (low computational cost), are fast in performance, and are flexible in that they can run on a central processing unit (CPU) environment across platforms. Additionally, the methods can be easily integrated into any of various image-based analyses (e.g., oral diagnostic measurements (e.g. overbite, gingiva recession, etc.) and/or dental appliance assessments (e.g., aligner fit)).

For example, described herein are methods comprising: registering a two-dimensional (2D) image of a subject's dentition with a three-dimensional (3D) representation of the subject's dentition; generating a pixel size scaling for the 2D image of the subject's dentition using the registered 3D representation, so that for each of one or more regions in the 2D image, the pixel size scaling comprises a scaling factor corresponding to each of the one or more regions indicating a size of the one or more pixels; and outputting the pixel size scaling. Any of these methods may include outputting a scaled image, e.g., an image scaled using the pixel size scaling (e.g., outputting a scaled 2D image). Any of these methods may include outputting one or more measurements made using the 2D image and the pixel size scaling, after applying the pixel size scaling to a region of the 2D image. As used herein, a subject may refer to a patient that may or may not be undergoing a medical (e.g., dental, orthodontic, etc.) procedure.

Any of these methods may include presenting a user interface with which a user (e.g., dental professional, technician, etc.) may select the 2D image, may select one or more regions to measure or estimate from the 2D image after determining the pixel size scaling, and/or may select (e.g., from a menu of options), one or more measurements to take using the pixel size scaling. In some examples the user interface may allow the user to select or confirm that a particular 3D model (and/or a particular intraoral scan corresponding to the 3D model) to use for determining the pixel size scaling for the 2D image. In some cases multiple 2D images may be processed using the same intraoral scan (or the same 3D model corresponding to a particular intraoral scan).

In some cases, the size of the pixels may be further adjusted (e.g., scaled) based on a correction ratio to correct for the orientation of the camera taking the 2D image relative to the region (e.g., tooth, teeth or region of teeth). The correction ratio maybe determined as a ratio of the corresponding distances between the aligned 3D model and the 2D image.

In any of these methods (and apparatuses for performing them) registering may include determining virtual camera parameters of a virtual camera such that a virtual image of the 3D representation taken with the virtual camera parameters matches the 2D image. Generating the pixel size scaling for the 2D image may comprise estimating different pixel size scaling for the one or more regions in the 2D image based on the virtual camera parameters including a ratio of a distance from the camera to the pixel and a distance from the camera to the 2D image.

In general, the 2D image of the subject's dentition may be segmented to identify individual teeth corresponding to the one or more regions within the 2D image. For example, any of these methods may include segmenting the 2D image to identify a plurality of individual teeth from the 2D image. The images may be segmented before registering the 2D image with the 3D representation. However, in some case the 2D image may not be segmented prior to registration with the 3D representation.

Any of these methods and apparatuses for performing them may include determining a length of a region of the 2D image using the pixel size scaling. For example, determining the length of the region of the 2D image using the pixel size scaling may include calculating and outputting the results of the calculation. Regions that may be calculated may include, but are not limited to one or more of: an overbite distance, an underbite distance, a posterior open bite distance, an interproximal spacing, and a distance between a tooth and an aligner.

In general, the size of the one or more pixels may be in units of length per pixel (e.g., micrometers per pixel, mm per pixel, etc.).

In any of these methods generating the pixel size scaling for the 2D image of the subject's dentition may comprise determining the scaling factor for each visible tooth in the 2D image. In some cases at least two of the visible teeth in the 2D image may have different pixel sizes.

Any of these methods may include selecting the 3D representation from a plurality of treatment plan 3D representations, wherein the selected 3D representation corresponds to a stage of a dental treatment plan that approximates the configuration of the subject's dentition in the 2D image. The selection of the 3D representation (which may alternatively be the selection of an intraoral scan data set from which a 3D representation may be generated), may be performed automatically or manually, or semi-automatically (e.g., suggested by the software). In some cases the 3D representation may be selected as the most recent scan. Alternatively the 3D representation may be selected based on the resolution (e.g., selecting a higher resolution 3D representation). In general, the 3D representation may have a relatively high resolution, e.g. having a voxel or pixel size that is less than 100 microns in size (e.g., less than 75 microns, less than 50 microns, less than 30 microns, etc.).

In general, registering the 2D image to the 3D model may include identifying common features between the 2D image and a projection (e.g., a 2D image projection) of the 3D model having a similar camera position as the 2D image. In some cases registration may comprise estimating a tooth shape based on a plurality of sample tooth shapes, and maximizing a fit of the estimated tooth shape with a corresponding tooth of the 2D image using principal component analysis (PCA). In some cases registering may comprise using a dental kinematics simulation framework to simulate a virtual image that matches the 2D image.

Generating a pixel size scaling for the 2D image of the subject's dentition may comprise, for each visible tooth, determining a distance between two points on the 3D model, and calculating a ratio of the distance over a number of pixels between corresponding points of the 2D image. In some cases the one or more regions in the 2D image may each include a crown center location of a tooth in the 3D model.

Outputting the pixel size scaling may comprise outputting a data structure representing different pixel sizes for the one or more regions of the 2D image.

For example, method may include: registering a two-dimensional (2D) image of a subject's dentition with a three-dimensional (3D) representation of the subject's dentition to determine virtual camera parameters of a virtual camera such that a virtual image of the 3D representation taken with the virtual camera parameters matches the 2D image; generating a pixel size scaling for the 2D image of the subject's dentition using the registered 3D representation of the subject's dentition and the virtual camera parameters to estimate a scaling factor, in units of length per pixel, for pixels in the 2D image; and determining a length of a region of the 2D image using the pixel size scaling.

In any of these examples, generating the pixel size scaling for the 2D image may comprise determining a field of pixel sizes across the 2D image. The virtual camera parameters may include a distance between the virtual camera and the 3D representation. Any of these methods may include selecting the 3D representation from a plurality of treatment plan 3D representations, wherein the selected 3D representation corresponds to a stage of a dental treatment plan that approximates the configuration of the subject's dentition in the 2D image.

As mentioned, registering may comprise estimating a tooth shape based on a plurality of sample tooth shapes, and maximizing a fit of the estimated tooth shape with a corresponding tooth of the 2D image using principal component analysis (PCA). In some cases registering comprises using a dental kinematics simulation framework to simulate a virtual image that matches the 2D image.

Generating a pixel size scaling for the 2D image of the subject's dentition may comprise, for each visible tooth, determining a distance between two points on the 3D model, and calculating a ratio of the distance over a number of pixels between corresponding points of the 2D image. In some cases generating a pixel size scaling for the 2D image of the subject's dentition using the registered 3D representation of the subject's dentition and the virtual camera parameters to estimate a scaling factor, comprises dividing a length of an image plane of the virtual camera by a number of pixels along the length of the image plane and, for each pixel in the 2D image, multiplying by a ratio of a distance from the virtual camera to the pixel and a distance from the camera to the 2D image.

In some cases determining the length of the region of the 2D image using the pixel size scaling may comprise calculating one or more of: an overbite distance, an underbite distance, a posterior open bite distance, an interproximal spacing, and a distance between a tooth and an aligner.

In general, any appropriate 2D image may be used. For example, the 2D image may comprise one of: a visible light image, an x-ray image, a panoramic image, a video image, and a stitched image based on two or more individual images.

For example, a method may include: registering a two-dimensional (2D) image of a subject's dentition with a three-dimensional (3D) representation of the subject's dentition, wherein the 3D representation is selected from a plurality of 3D representations to approximate the configuration of the subject's dentition in the 2D image, to identify an aligned orientation of the 3D representation, wherein the registering comprises identifying a virtual camera position relative to the patient's dentition in the 3D representation to match the subject's dentition in the 2D image, further wherein the 2D image is segmented to identify individual teeth within the 2D image; generating a pixel size scaling for the 2D image of the subject's dentition using the aligned 3D representation, wherein generating the pixel size scaling for the 2D image comprises estimating a pixel size for each visible tooth in the 2D image based on the virtual camera position; and outputting the pixel size scaling.

In some examples, a method may include: registering a two-dimensional (2D) image of a subject's dentition with a three-dimensional (3D) representation of the subject's dentition, wherein the 3D representation is selected from a plurality of 3D representations and approximates the configuration of the subject's dentition in the 2D image, to identify an aligned orientation of the 3D representation, wherein the registering comprises identifying a virtual camera having virtual camera properties such that a virtual image of the 3D representation taken with the virtual camera properties matches the 2D image, further wherein the 2D image is segmented to identify individual teeth within the 2D image; generating a pixel size scaling for the 2D image of the subject's dentition comprising a field of pixel scaling factors for each pixel of the 2D image so that each pixel has a corresponding scaling factor, in units of length per pixel, determined from a length of all or a portion of an image plane divided by a number of pixels in the length of all or a portion of the image plane, and multiplied by a ratio of the distance from the virtual camera to the pixel and a distance from the virtual camera to the image plane; and outputting the pixel size scaling.

Also described herein are systems that may be configured to perform any of these methods. For example a system may include a computing device with a non-transitory computer-readable data storage having instructions which can be executed by one or more processors to cause the computing device to: register a two-dimensional (2D) image of a subject's dentition with a three-dimensional (3D) representation of the subject's dentition; generate a pixel size scaling for the 2D image of the subject's dentition using the registered 3D representation, so that for each of one or more regions in the 2D image, the pixel size scaling comprises a scaling factor corresponding to each of the one or more regions indicating a size of the one or more pixels; and output the pixel size scaling.

The instructions may be further configured to register the 2D image with the image of a subject's dentition with the 3D representation of the subject's dentition by determining virtual camera parameters of a virtual camera such that a virtual image of the 3D representation taken with the virtual camera parameters matches the 2D image, and wherein generating the pixel size scaling for the 2D image comprises estimating different pixel size scaling for the one or more regions in the 2D image based on the virtual camera parameters including a ratio of a distance from the camera to the pixel and a distance from the camera to the 2D image. The 2D image of the subject's dentition may be segmented to identify individual teeth corresponding to the one or more regions within the 2D image. The instructions may be further configured to determine a length of a region of the 2D image using the pixel size scaling. The instructions may be further configured to determine the length of the region of the 2D image using the pixel size scaling comprises calculating one or more of: an overbite distance, an underbite distance, a posterior open bite distance, an interproximal spacing, and a distance between a tooth and an aligner. The size of the one or more pixels may be in units of length per pixel. The instructions may be further configured to segment the 2D image to identify a plurality of individual teeth from the 2D image. The instructions may be further configured to generate the pixel size scaling for the 2D image of the subject's dentition comprises determining the scaling factor for each visible tooth in the 2D image. In some cases at least two of the visible teeth in the 2D image may have different pixel sizes. The instructions may be further configured to select the 3D representation from a plurality of treatment plan 3D representations, wherein the selected 3D representation corresponds to a stage of a dental treatment plan that approximates the configuration of the subject's dentition in the 2D image. In some cases the instructions may be further configured to register by estimating a tooth shape based on a plurality of sample tooth shapes, and maximizing a fit of the estimated tooth shape with a corresponding tooth of the 2D image using principal component analysis (PCA). In some examples the instructions are further configured to register using a dental kinematics simulation framework to simulate a virtual image that matches the 2D image. The instructions may be further configured to generate a pixel size scaling for the 2D image of the subject's dentition comprises, for each visible tooth, determining a distance between two points on the 3D model, and calculating a ratio of the distance over a number of pixels between corresponding points of the 2D image. In some examples, one or more regions in the 2D image may each include a crown center location of a tooth in the 3D model.

The instructions may be further configured to output the pixel size scaling by outputting a data structure representing different pixel sizes for the one or more regions of the 2D image.

A system may include a computing device with a non-transitory computer-readable data storage having instructions which can be executed by one or more processors to cause the computing device to: register a two-dimensional (2D) image of a subject's dentition with a three-dimensional (3D) representation of the subject's dentition to determine virtual camera parameters of a virtual camera such that a virtual image of the 3D representation taken with the virtual camera parameters matches the 2D image, generate a pixel size scaling for the 2D image of the subject's dentition using the registered 3D representation of the subject's dentition and the virtual camera parameters to estimate a scaling factor, in units of length per pixel, for pixels in the 2D image; and determine a length of a region of the 2D image using the pixel size scaling.

In some examples a system may include a computing device with a non-transitory computer-readable data storage having instructions which can be executed by one or more processors to cause the computing device to: register a two-dimensional (2D) image of a subject's dentition with a three-dimensional (3D) representation of the subject's dentition, wherein the 3D representation is selected from a plurality of 3D representations and approximates the configuration of the subject's dentition in the 2D image, to identify an aligned orientation of the 3D representation, wherein the registering comprises identifying a virtual camera having virtual camera properties such that a virtual image of the 3D representation taken with the virtual camera properties matches the 2D image, further wherein the 2D image is segmented to identify individual teeth within the 2D image; generate a pixel size scaling for the 2D image of the subject's dentition comprising a field of pixel scaling factors for each pixel of the 2D image so that each pixel has a corresponding scaling factor, in units of length per pixel, determined from a length of all or a portion of an image plane divided by a number of pixels in the length of all or a portion of the image plane, and multiplied by a ratio of the distance from the virtual camera to the pixel and a distance from the virtual camera to the image plane; and output the pixel size scaling.

In some cases scaling the 2D image may include applying a ratio of the sizes (e.g. lengths) of corresponding regions in the 3D representation and the 2D image. For example, scaling the 2D image may include determining a pixel size for discrete visible regions in the 2D image, such as for each visible tooth in the 2D image. The discrete visible regions may have different pixel sizes; for example, at least two of the visible teeth in the 2D image may have different pixel sizes. Scaling the 2D image may include determining a field of pixel sizes across the 2D image.

Also described herein are methods and apparatuses that may provide enhanced accuracy when determining pixel scaling from a 2D image, such as a 2D image captured by a patient, by estimating the pose of the dental features (e.g., jaws) in 3D space and uses a 3D transformation to eliminate any measurement error caused by camera orientation. The methods and apparatuses described herein may include using the pixel size information (e.g., pixel size scaling) and the ratio of one or more regions (e.g., between 2 points) in both the 2D image and the 3D representation to estimate the size of another region of the 2D image.

For example, described herein are methods that may include: identifying a corresponding two or more points on both a two-dimensional (2D) image of a subject's dentition and a three-dimensional (3D) model of the subject's dentition, wherein the 2D image and the 3D model have been registered to each other; determining a distance between the corresponding two or more points on the 3D model; determining a distance between the corresponding two or more points on the 2D image by projecting the distance between the corresponding two or more points on the 3D model onto the 2D image using the camera position and/or orientation; determining a pixel size scaling for the 2D image from a number of pixels between the corresponding two or more points on the 2D image and the distance between the corresponding two or more points on the 2D image; determining a correction ratio comprising a ratio of the distance between the corresponding two or more points on the 3D model and the distance between the corresponding two or more points on the 2D image; and estimating a distance of a region of the 2D image using the pixel size scaling, a number of pixels extending along the region, and the correction ratio.

In general, two or more points may include a pair of points, three points, four points, five points, or more. The two or more points may define a line segment, a line, a curved line, a polygon, etc.

Any of these methods may include determining the distance between the corresponding two or more points on the 2D image comprises using a camera angle relative to the 3D model. These method may include registering, or accessing a registration of, the 2D image and the 3D model of the subject's dentition.

In general, these methods may include identifying the corresponding two or more points on both the 2D image and the 3D model comprises identifying a first two or more points on the 3D model and using the registration of the 2D image and the 3D model to identify a second two or more points on the 2D image corresponding to the first two or more points on the 3D model.

In any of these methods the two or more points of the distance of the region from the 2D image may be in-line with the corresponding two or more points on the 2D image. These methods may be used to estimate one or more regions (e.g. different region) from the 2D image. Estimating the distance of the region from the 2D image may comprise estimating an overbite. In some examples, estimating the distance of the region from the 2D image comprises estimating a spacing between a dental apparatus and the subject's dentition. In some examples estimating the distance of the region from the 2D image comprises estimating gingival recession.

The 3D model may be taken at an earlier stage of a dental treatment and the 2D image is taken at a later stage of the dental treatment. In some examples, estimating the distance of the region from the 2D image comprises dividing the distance into a plurality of segments, and estimating a distance of each segment using the pixel size scaling, the number of pixels extending along each segment, and the correction ratio.

Any of these methods may include outputting the distance of the region of the 2D image.

For example, a method may include: registering, or accessing a registration of, the 2D image and a three-dimensional (3D) model of the subject's dentition; identifying a corresponding two or more points on both the 2D image and the 3D model; determining a distance between the corresponding two or more points on the 3D model; determining a distance between the corresponding two or more points on the 2D image by projecting the distance between the corresponding two or more points on the 3D model onto the 2D image using a camera angle relative to the 3D model; determining a pixel size scaling for the 2D image from a number of pixels between the corresponding two or more points on the 2D image and the distance between the corresponding two or more points on the 2D image; determining a correction ratio comprising a ratio of the distance between the corresponding two or more points on the 3D model and the distance between the corresponding two or more points on the 2D image; estimating a distance of a region of the 2D image using the pixel size scaling, a number of pixels extending along the region, and the correction ratio; and outputting the distance of the region.

As mentioned, any of the methods described herein may be performed by a system configured to perform these methods. For example, described herein are systems comprising a computing device with a non-transitory computer-readable data storage having instructions which can be executed by one or more processors to cause the computing device to: identify a corresponding pair of two or more points on both a two-dimensional (2D) image of a subject's dentition and a three-dimensional (3D) model of the subject's dentition, wherein the 2D image and the 3D model have been registered to each other; determine a distance between the corresponding pair of two or more points on the 3D model; determine a distance between the corresponding two or more points on the 2D image by projecting the distance between the corresponding two or more points on the 3D model onto the 2D image using the camera position and/or orientation; determine a distance between the corresponding pair of points on the 2D image, based on the number of pixels between the corresponding pair of points on the 2D image and a pixel size scaling for the 2D image from a number of pixels between the corresponding two or more points on the 2D image and the distance between the corresponding two or more points on the 2D image; determine a correction ratio comprising a ratio of the distance between the corresponding pair of two or more points on the 3D model and the distance between the corresponding pair of two or more points on the 2D image; and estimate a distance of a region of the 2D image using the pixel size scaling, the a number of pixels extending along the region, and the correction ratio of the distance between the corresponding pair of points on the 3D model and the distance between the corresponding pair of points on the 2D image.

The instructions may be further configured to determine the distance between the corresponding two or more points on the 2D image comprises using a camera angle relative to the 3D model. In some cases the instructions are further configured to cause the computing device to register, or access a registration of, the 2D image and the 3D model of the subject's dentition. The instructions maybe configured to cause the computing device to identify the corresponding two or more points on both the 2D image and the 3D model by identifying a first two or more points on the 3D model and using the registration of the 2D image and the 3D model to identify a second two or more points on the 2D image corresponding to the first two or more points on the 3D model.

In any of these systems, two or more points of the distance of the region from the 2D image are in-line with the corresponding two or more points on the 2D image. The instructions may be configured to cause the computing device to estimate an overbite as the distance of the region from the 2D image.

The instructions may be configured to cause the computing device to estimate a spacing between a dental apparatus and the subject's dentition as the distance of the region from the 2D image. The instructions may be configured to cause the computing device to estimate a gingival recession as the distance of the region from the 2D image. In some cases the instructions are configured to cause the computing device to estimate the distance of the region from the 2D image by dividing the distance into a plurality of segments, and estimating a distance of each segment using the pixel size scaling, the number of pixels extending along each segment, and the correction ratio. The instructions may be configured to cause the computing device to output the distance of the region of the 2D image.

For example, a system may comprise a computing device with a non-transitory computer-readable data storage having instructions which can be executed by one or more processors to cause the computing device to: register or access a registration of, the 2D image and a three-dimensional (3D) model of the subject's dentition; identify a corresponding pair of two or more points on both the 2D image and the 3D model; determine a distance between the corresponding pair of two or more points on the 3D model; determine a distance between the corresponding pair of two or more points on the 2D image based on the number of pixels between the corresponding pair of point on the 2D image and the pixel size scaling for the 2D image; by projecting the distance between the corresponding two or more points on the 3D model onto the 2D image using a camera angle relative to the 3D model; determine a pixel size scaling for the 2D image from a number of pixels between the corresponding two or more points on the 2D image and the distance between the corresponding two or more points on the 2D image; determine a correction ratio comprising a ratio of the distance between the corresponding pair of two or more points on the 3D model and the distance between the corresponding pair of two or more points on the 2D image; estimate a distance of a region of the 2D image estimating a distance between two or more points on the 2D image using the pixel size scaling, the a number of pixels between the two or more points extending along the region, and the correction ratio of the distance between the corresponding pair of points on the 3D model and the distance between the corresponding pair of points on the 2D image; and output the distance between the two or more points of the region.

All of the methods and apparatuses described herein, in any combination, are herein contemplated and can be used to achieve the benefits as described herein.

### BRIEF DESCRIPTION OF THE DRAWINGS

A better understanding of the features and advantages of the methods and apparatuses described herein will be obtained by reference to the following detailed description that sets forth illustrative embodiments, and the accompanying drawings of which:

FIG. 1 is a flowchart indicating an example method of scaling an image based on different pixel sizes.

FIGS. 2A-2E show example aspects of a 3D to 2D registration.

FIG. 3 shows an example graph showing estimated pixel sizes resulting from using different registration methods implemented on the image of FIG. 2A.

FIG. 4A illustrates an example camera set up for estimating pixel sizes.

FIG. 4B illustrates an example image of a subject's teeth.

FIG. 4C illustrates an example of a segmented image of a dentition.

FIG. 4D illustrates an example scaled image of the dentition of FIG. 4C.

FIG. 5A illustrates an example simulation setup for acquiring a panoramic image of a virtual dental arch.

FIGS. 5B and 5C illustrate example images of upper and lower arches, respectively, with 3D models overlaid and registered to 2D radiograph images.

FIGS. 5D and 5E illustrate example scaled images of upper and lower jaws, respectively, represented as pixel size fields and resulting from using the simulation registration setup of FIG. 5A.

FIG. 6 is a block diagram of an example system for estimating pixel sizes and scaling one or more images.

FIGS. 7A-7B illustrate an example of a 3D model of a subject's jaws in world space.

FIG. 8A shows an example of a 2D image of the subject's jaws (in camera space).

FIGS. 8B-8C illustrate a representation of the subject's jaws in the camera space.

FIG. 9 schematically illustrates a simplified model of the conversion between the world space and the camera space, e.g., of an object such as a tooth.

FIGS. 10A-10C illustrate an example of measuring a height of a tooth from a 2D image (e.g., in camera space) using a world to camera ratio and information about the pixel size (e.g., the pixel size scaling).

FIG. 11 is a flowchart indicating an example method of estimating a distance of a region of a 2D image using pixel size scaling, the 2D image and the world to camera ratio (e.g., the ratio of the distance between the corresponding two or more points on a 3D model and the distance between the corresponding two or more points on the 2D image).

### DETAILED DESCRIPTION

Images, such as dental images, are widely used in the formation and monitoring of a dental treatment plan. For example, some dental images may be used to determine whether the teeth of a patient undergoing orthodontic treatment are on track according to an orthodontic treatment plan. Some dental images may be used to determine the starting point of a dental treatment plan, or in some cases, determine whether a patient is a viable candidate for any of a number of different dental treatment plans. Some dental images may be used to determine whether the patient has a dental condition that needs treatment. One of the problems associated with analyzing images is that the resolution of objects that are closer to the camera may be greater than objects that are farther from the camera.

Described herein are apparatus (e.g., systems and devices, including software) and methods that provide a framework using three-dimensional (3D) to two dimensional (2D) registration to estimate pixel sizes at different locations of a 2D image. The estimated pixel sizes may be used as conversion factors for converting pixels of the 2D image to 3D measurements (e.g., micrometers), which provides for improved resolution of features in the 2D image compared to conventional image analysis techniques.

The methods and apparatuses described herein may be used to provide a pixel size scaling to allow accurate (to scale) measurements from 2D images taken with virtually any camera, including patient cameras (e.g., smartphone cameras, etc.). These methods and apparatuses may provide scaled 2D images, e.g., pixel size scaling for 2D images, in which different regions of the 2D image may have different pixel sizes. The pixel size scaling for the 2D image may take into account camera parameters (e.g., distance, angle, orientation) of the camera that acquired the 2D image. For example, some objects may be farther away from and/or at different angles with respect to the camera compared to other objects. The pixel size scaling may then be used to identify and/or analyze features of objects in the 2D image to a high level of accuracy, for example, at a sub-millimeter (e.g., micrometer) scale.

The pixel size estimation techniques described herein may be well-suited for many image-based dental applications, such as oral diagnostics (e.g. determining overbite, underbite and/or other dental condition), determining aligner fit, or other image-based applications. Measurements in a 2D image can be made in terms of pixels. The methods may include using a 3D representation (e.g., 3D model) of a subject's teeth to convert the pixel measurements to 3D physical measurements by way of the pixel size. That is, the pixel size is a value that provides a conversion of a 2D image-based measurement into a 3D measurement. The pixel sizes may then be used as a basis for analysis of the 2D image (either individually or in combination with other 2D images) for dental diagnostics, dental appliance (e.g., aligner) adjustment and/or other dental analysis applications.

The methods described herein are well-suited for providing accurate analysis and resolution of features in images taken by a phone camera or other consumer hand-held camera. Typically, a patient takes a picture of their teeth (or another person's teeth) at a distance of about 16 to 20 inches from their face (or other person's face). This is different than many types of images taken in the dental office, such as those taken using an intraoral scanner, which are taken at a much closure distance (e.g., a few inches) to the patient's teeth. The longer distance between the phone camera or other consumer hand-held camera and the teeth may result in a greater resolution variability of the teeth in the resulting image compared to images taken using a camera very close to the teeth (e.g., at dental office). The differential pixel size and scaling described herein may be used to compensate for the greater resolution variability.

In a simplified case, one pixel size is estimated over the entire image based on an object within the image having known size, such as the facial axis of the clinical crown (FACC) line of each tooth. The FACC line is an object in the treatment plan and is typically provided in measurements of millimeters (mm). The size of a pixel can be estimated by examining the FACC line, for example, of the anterior teeth. The length of the FACC line in the image, as measured in pixels, can be estimated from the height of the respective tooth (in pixels). Dividing the length of the FACC by the height in pixels yields a pixel size estimate in length (e.g., mm) per pixel. Since this number is frequently noisy, the pixel size may be an average over multiple teeth to identify a single pixel size for the entire image. There are challenges, however, with using FACC lines as a basis and with having a single pixel size for the entire image. For example, the length of a FACC line of a tooth that is angulated or inclined relative to the camera will not accurately correspond to the tooth height in pixels, resulting in inaccurate estimates of pixel size.

The techniques described herein may be used to estimate pixel sizes in a way that takes into account camera parameters (e.g., distance, angle, orientation) of the camera that acquired the image. The camera parameters may be determined by registering a 3D representation of the teeth with teeth in the image. The estimated pixel size may then be calculated based on the a more accurate matching of the 3D measurements (e.g., mm) and pixels. The estimated pixel sizes may be used to scale the 2D image. As used herein, scaling refers to representing in proportional dimensions (e.g., by reducing or increasing relative sizes) according to a common scale. The pixel size scaling may then be used to identify and/or analyze features of objects in the 2D image to a high level of accuracy, for example, at a sub-millimeter (e.g., micrometer) scale.

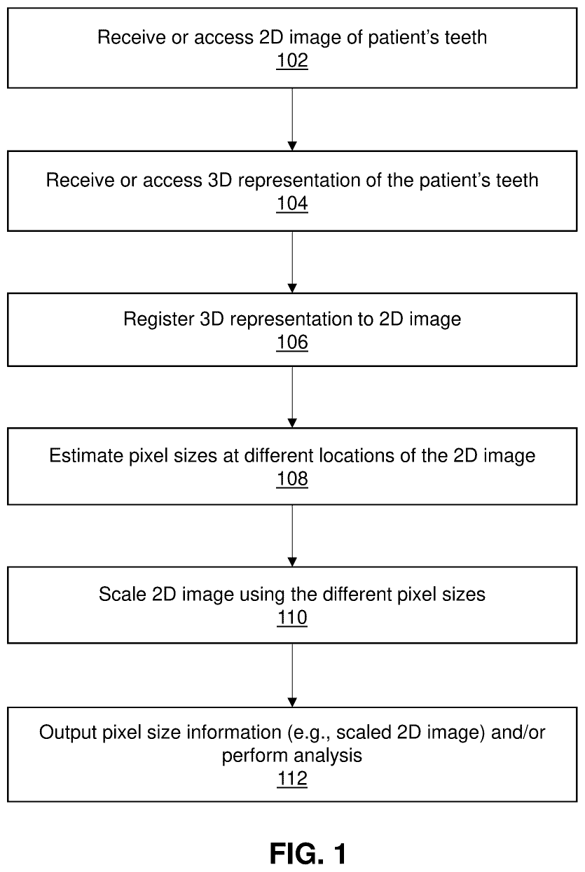

FIG. 1 is a flowchart depicting an example method of determining pixel size scaling, which may be used to generate a scaling map for a 2D image. At 102, one or more 2D images of a patient's teeth are received. The 2D image may be a digital image represented as a collection of pixels. The 2D image may include a photographic image (e.g., from a camera), an x-ray image (e.g., cone beam computed tomography (CBDT image)), a visible light image, an infrared (e.g., near infrared) image, a panoramic image (e.g., from a dental scan), a video image, a stitched image based on two or more individual images, or any combination thereof. In some examples, the 2D image may be taken using a single shot imagery system where the camera is in a fixed position relative to the patient's teeth. In some examples, the 2D image may be taken using a continuously scanning imagery system where the camera is moving, for example, to capture a wide view of the patient's teeth (e.g., panoramic x-ray). In some cases, the 2D image is a picture taken from a user's phone camera or other hand-held camera. In other cases, the 2D image is taken as part of a dental scan of the patient's teeth (e.g., using an intra-oral scanner). The 2D image may include one or more visible teeth of the patient's dentition. In some cases, the 2D image(s) include a dental appliance (e.g., removeable aligner) on the patient's teeth. In some applications, the 2D image(s) are of the patient's teeth are taken at a certain time to establish a current condition of the teeth, such as between dental office visits to track the progress of a dental treatment plan.

At 104, one or more 3D representations of the patient's teeth is received. The 3D representation (e.g., virtual 3D model) includes measurement information in 3D space. For example, the 3D representation includes dimensional information (e.g., length and width) for each tooth. The 3D representation may be selected from a number of treatment plan 3D representations of the patient's teeth. The selected 3D representation may correspond to a stage of a dental treatment plan that approximates the configuration of the patient's dentition in the 2D image. For example, the 2D image may be acquired at a time between stages of the treatment plan and before the next aligner in a series of aligners is used by the patient. The 3D representation may be segmented to such that different features (e.g., teeth, gums, and/or other oral features) of the patient's dentition are partitioned and identified. In some cases, each tooth in the 3D representation is labeled according to tooth type (e.g., molar, pre-molar, incisor, canine) and/or tooth number.

The 3D representation may include a digital 3D model comprising a tooth mesh. The 3D model may comprise a point cloud model (e.g., a tooth point cloud, or a point cloud model of a tooth or teeth). In some cases, the 3D model may include a reduced representation of a 3D dental model, such as a principal component analysis representation.

At 106, the 3D representation is registered to the 2D image. This may involve aligning features (e.g., teeth, gums, and/or other oral features) of the 3D representation with corresponding features in the 2D image. The 2D image may be digitally segmented based on the 3D representation such that the different features in the image are partitioned and identified. In some cases, each visible tooth in the 2D image is labeled according to tooth type (e.g., molar, pre-molar, incisor, canine) and/or tooth number. In some examples, the 2D image is already segmented prior to registering with the 3D representation.

The 3D to 2D registration may be used to determine virtual camera parameters of a virtual camera corresponding to camera parameters of a camera used to take the 2D image. The camera parameters may include the distance between the camera and the patient's dentition, camera focal length, camera aperture, camera focusing distance, camera angle and orientation, and/or other properties.

The 3D to 2D registration may be accomplished using any of a number of different optimization schemes involving any of a number of analysis techniques, such as statistical analysis and/or machine learning techniques. Because optimization/analysis techniques may differ, pixel size estimations based on registration using different techniques may differ. Two registration techniques described herein include: an expectation and maximization technique, and a machine-learning-based differentiable dental kinematics simulation technique. It should be noted that the methods described herein are not limited to these two example registration techniques, and that one or more alternative or additional registration techniques may be used to estimate pixel sizes. Further, in some examples, aspects of each of these two registration techniques may be combined.

In some examples an expectation and maximization technique may be used. This registration technique is a statistical technique that is used to find the most probable parameters of the virtual camera for providing the 2D image. This technique involves estimating a tooth shape based on a number of sample tooth shapes (e.g., from a database of tooth shapes), and maximizing a fit of the estimated tooth shape with a corresponding tooth of the 2D image using principal component analysis (PCA). In some cases, edge detection techniques are to determine the edges and shapes of the teeth in the 2D image. Once the teeth edges are determined, you can establish which teeth are visible in the 2D image, where the teeth are located within the 2D image, and which teeth in the 2D image correspond to particular teeth in the 3D representation. An average tooth shape from samples (e.g., hundreds of samples) in the database may be used in the 3D model. In some cases, pretrained PCA components for a particular 3D tooth shape may be used to determine the best match with the 2D image.

In some examples a machine-learning-based differentiable dental kinematics simulation may be used. This registration technique is a machine-learning-based framework used to optimize the 3D to 2D registration. Such a framework may be based on automatic differentiation, which involves evaluating the partial derivative of specified functions. Such simulation framework may involve generating a simulated 2D image that matches the actual 2D image, then determining what camera parameters (e.g., distance, angle, etc.) are used to generate the simulated 2D image. Since the images match, the camera parameters used to generate the simulated 2D image should match the camera parameters used to generate the actual 2D image.

Once the 3D representation and 2D image are registered (sufficient alignment is achieved) and the corresponding camera parameters are determined, at step 108, the pixel sizes at different locations of the 2D image are estimated. In general, smaller pixel sizes are associated with the higher the resolution. The pixel sizes of objects closer to the camera are likely to be smaller than the pixel sizes of objects farther from the camera. Thus, different pixel sizes may be estimated for different regions and/or different objects (e.g., teeth, gums, etc.) in the 2D image, thereby providing a way to scale the 2D image to take into account the resolution quality of the different regions/objects in the image. This approach provides a way to accurately resolve features that cannot be resolved using techniques where only one pixel size is identified for an entire image. Optionally, the system may generate a data structure (e.g., array) of pixel size scaling associated with the 2D image, including different regions. This may be referred to as scaling the 2D image 110.

In some examples, the pixel size is estimated on a per-object basis. That is, each object (e.g., tooth) is associated with an estimated pixel size. This may involve using the crown centers of adjacent teeth to compute 3D physical distance between the adjacent teeth. The 3D physical distance may be mapped to the 2D image to determine the corresponding 2D pixel distance. Then, an “average” pixel size may be approximated as the ratio of two adjacent crown centers. This process can be repeated for adjacent teeth until each tooth is associated with a corresponding pixel size.

In other examples, the pixel size is represented as a pixel size field across the 2D image. This involves leveraging the 3D to 2D registration to create an array of pixel sizes that is the same size as the 2D image, where each element in the array corresponds to a single pixel and represents the real-world size of that pixel. Constructing a pixel size field allows for very precise measurement of an image feature since each pixel may have a slightly different size (based on the relative location of the camera and the feature at the pixel). In addition, constructing a pixel size field allows for the interpolation and/or extrapolation of pixel sizes to regions of the image where a known object does not exist.

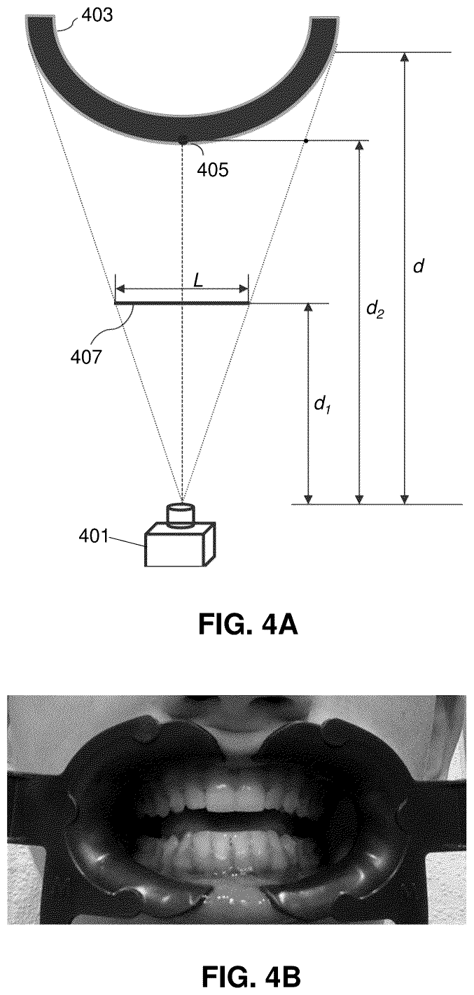

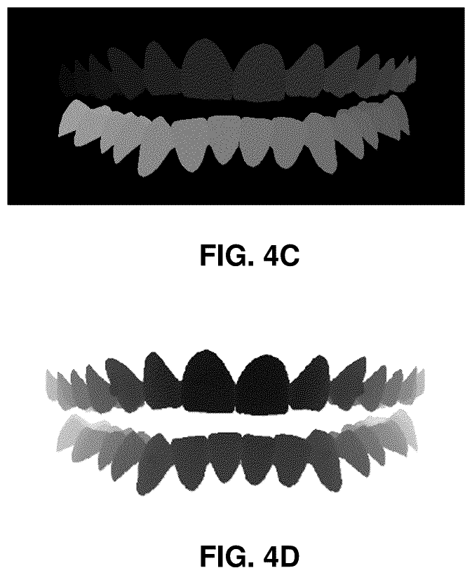

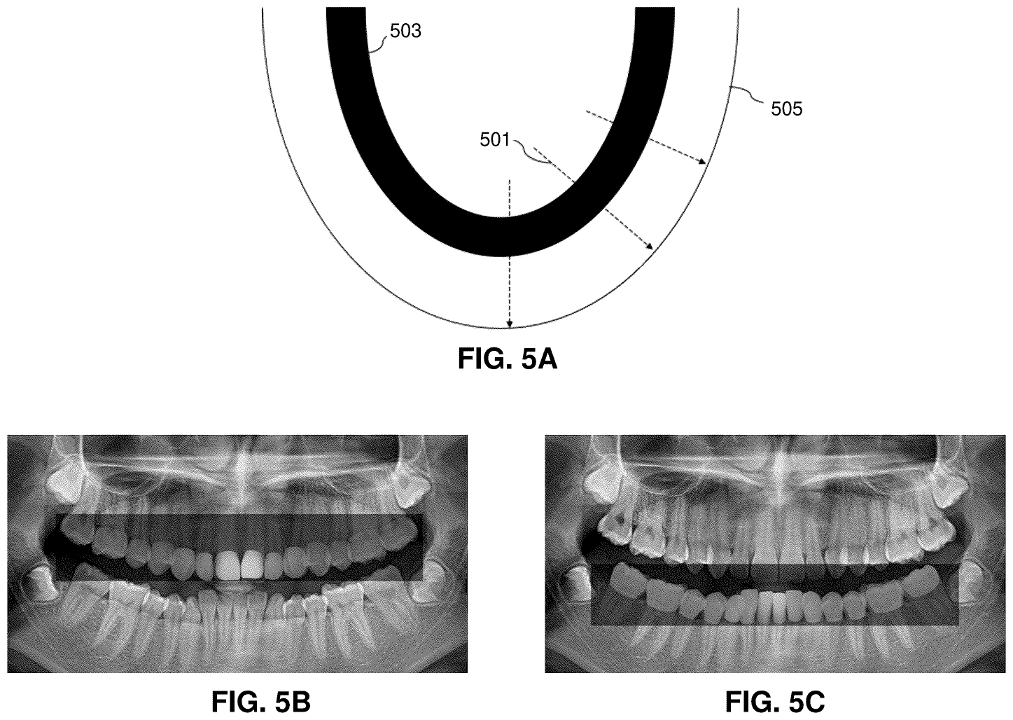

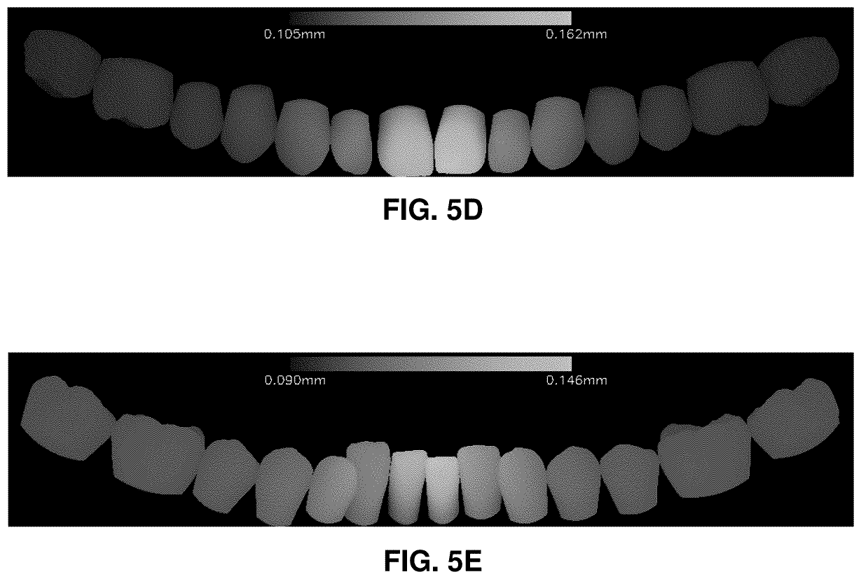

At 112, the scaled image data is generated as output and/or the pixel size information (e.g., pixel size scaling) over the 2D image may be generated. In any of these examples a 2D mapping of the pixel size scaling may be provided, correlating to the original 2D image. This scaling map may be referred to herein as a scaled image data. The scaled image data may correlate the pixel size information for different regions of the 2D image, on regional basis (e.g., groups or subsets of pixels, which may correspond to different segmentation features, such as teeth), or on individual pixels of the 2D image. The pixel size information, in some cases in the form of the scaled image data, may be used to perform further image analysis on the patient's teeth. For example, the output may include a scaled 2D image indicating different pixel sizes for different regions and/or for individual pixels (e.g., FIGS. 4D, 5D or 5E). In some examples, the output includes the scaled data in the form of a data structure, such as an array or matrix. The scaled data may be used as a basis to resolve, measure and/or compare fine features for evaluation and/or diagnostic purposes, as described herein. In some cases, the scaled image data is combined with other image data, such as other scaled image data of the patient's teeth (e.g., from different angles/positions), to provide a more complete overall image of the patient's teeth.

### Per-Object Pixel Size Estimation

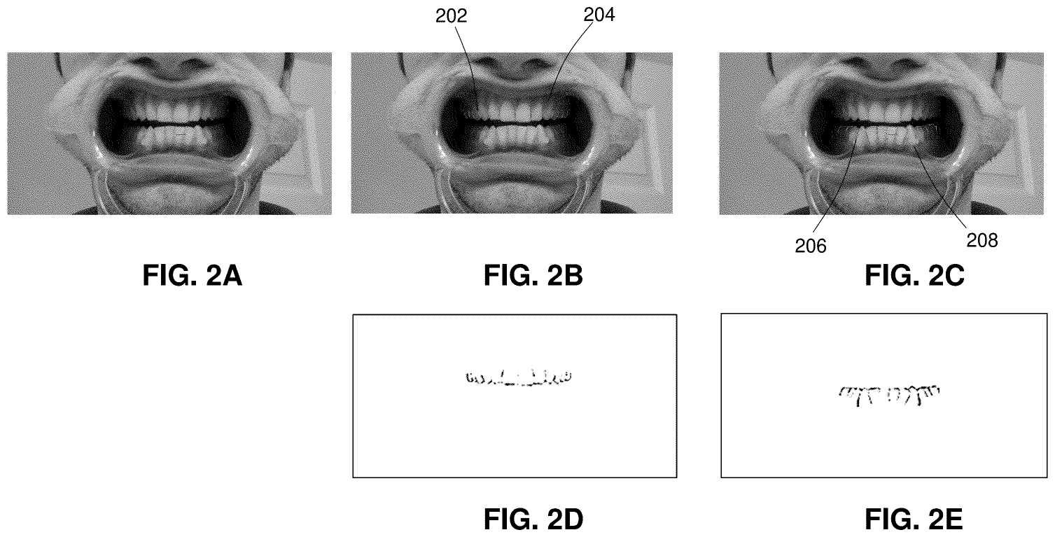

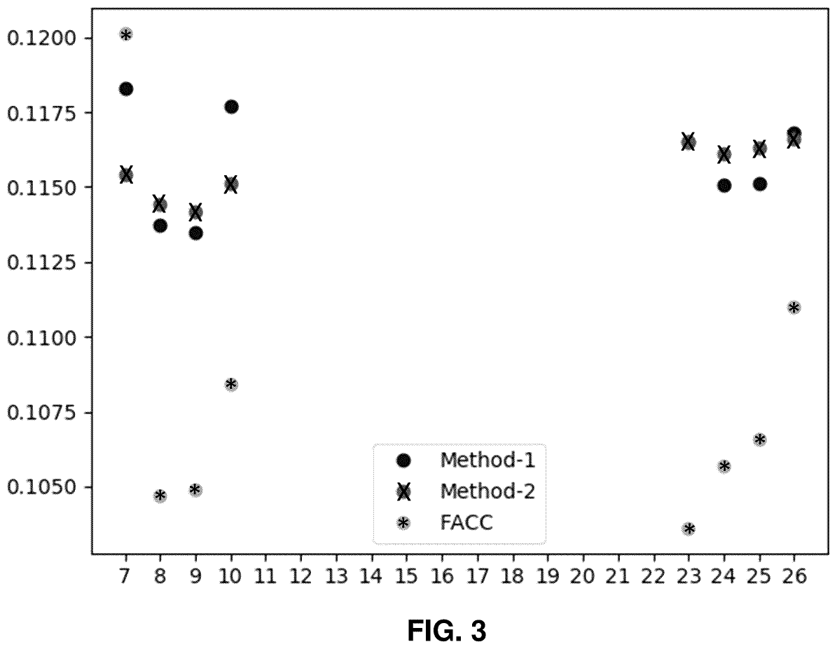

FIGS. 2A-2E and 3 illustrate aspects related to estimating pixel size on a per-object basis, where each object (e.g., tooth) is associated with an estimated pixel size. FIGS. 2A-2E show example aspects of a 3D to 2D registration. FIG. 2A shows a 2D image of a subject's teeth (i.e., input image) taken during mid-treatment (between treatment stages). A 3D model of the subject's teeth at the closest stage of treatment according to a treatment plan is chosen and registered with the 2D image. Both the 2D image and the 3D model are segmented, so that boundaries of individual teeth are identified, and tooth contours of the segmented teeth are generated. FIG. 2B shows a 2D image tooth contour 202 of the subject's lower jaw and the 3D model contour 204 of the subject's lower jaw overlaid and aligned with teeth of the lower jaw of the 2D image. FIG. 2C shows a 2D image tooth contour 206 of the subject's upper jaw and the 3D model contour 208 of the subject's upper jaw overlaid and aligned with teeth of the upper jaw of the 2D image. FIG. 2D shows the difference of input and aligned tooth segmentations of the subject's lower jaw. FIG. 2E shows the difference of input and aligned tooth segmentations of the subject's upper jaw. As shown, the projected 3D model contours 204/208 very closely match with corresponding 2D image contours 202/206. This indicates that simulated data generated from a 3D model (projected contours 204/208) can be accurately matched with the real data (2D image contours 202/206). As described herein, the 3D to 2D registering/aligning may be optimized using one or more optimizing processes. Once sufficiently registered/aligned, the camera parameters can be determined based on the 3D model, and the pixel sizes can be estimated (e.g., for each tooth or as a pixel field), as described herein.

FIG. 3 is a graph showing estimated pixel sizes resulting from using different registration methods on the example image of FIG. 2A. The graph indicates the estimated pixel size per tooth of the front four teeth of both jaws (tooth 7, 8, 9 and 10 for upper jaw; and tooth 23, 24, 25, 26 for lower jaw). The x-axis is tooth number, and the y-axis is estimated pixel size per tooth (mm/pixel). “Method 1” refers to the expectation and maximization registration method previously discussed. “Method 2” refers to the machine-learning-based differentiable dental kinematics simulation registration method previously discussed. In both the Method 1 and 2 examples, the pixel size for each tooth is estimated based on measuring the distance of two points (e.g., adjacent crown centers) in the 3D model and calculating the ratio of the distance over the corresponding pixel distance between two points of the 2D image. “FACC” refers to a facial axis of the clinical crown (FACC) method in which the FACC line of each tooth is used to estimate pixel size.

As shown by the graph of FIG. 3, there is less variation in pixel sizes using the registration Methods 1 and 2 compared to the pixel sizes using the FACC registration method. Additionally, using the registration Methods 1 and 2 results in pixel sizes of central incisors (8, 9, 24 and 25) that are smaller than the pixel sizes of lateral incisors (7, 10, 23 and 26). This is consistent with what is expected since the central incisors are closer to the camera than the lateral incisors in the image (FIG. 2A). In comparison, the pixel sizes estimated using the FACC registration method are much less consistent. For example, using the FACC registration method, the estimated pixel size for the lateral incisor 23 is less than the pixel sizes of the central incisors 24 and 25, which is inconsistent with the camera position.

Pixel Size Fields are illustrated in FIGS. 4A-4B and 5A-5E. FIGS. 4A-4B and 5A-5E illustrate aspects of constructing a field of pixel sizes, where an image is associated with an array of single pixel sizes.

FIG. 4A shows example aspects of constructing a field of pixel sizes for a 2D image collected from a fixed camera 401. The camera 401 is positioned a distance d₂ away from a focal point 405 of a dental arch 403. The image plane 407 is located a distance d₁ away from the camera 401. The size of the image plane 407 is of length L with N pixels. We can calculate the size of pixel corresponding to the distance d₂ of the focal point 405 as:

$${s}_{f} = \frac{L}{N} \times \frac{{d}_{2}}{{d}_{1}}$$

This is the physical size of the pixel corresponding to the object surface point in focus (focal point 405). Technically, all other surface points of the object are out of focus. As a result, for pixels corresponding to object surface points that are out of focus, the per-pixel size estimate reads as follows:

$${s}_{d} ≅ \frac{L}{N} \times \frac{d}{{d}_{1}}$$

As indicated, per-pixel size is dependent on the depth d of the corresponding object surface point. When d=d₂, the pixel size estimate sa is reduced to sf. Using this approach, we can take a single image of the patient's teeth, such as the one shown in FIG. 4B.

FIGS. 4C and 4D show example images indicating a field of pixel sizes for a single shot approach. FIG. 4C shows a segmented image of the teeth where all the teeth have been identified. FIG. 4D shows a scaled image of the teeth after 3D to 2D registration and the pixel size of all pixels have been estimated, resulting in a field of pixel sizes. As shown, the different pixel sizes are represented with different shades (e.g., different grayscale shades and/or different colors). In this example, the pixel sizes range from 0.114 mm to 0.130 mm. This means that if a single pixel size were to be used for the whole image (e.g., based on the upper central incisors), that result would be 12% too small for pixels in the posterior of the arch. Optionally, the pixels that fall outside of the measured range may be interpolated/extrapolated based on the pixels that were measured. This can be useful when measuring gingival recession or other gingival features that are not in the 3D model, but that are close to objects in the 3D model. Additionally, if a gingival mesh is provided, the image can be registered to that mesh directly and provide exact pixel size calculations.

FIGS. 5A-5E illustrate example aspects of constructing a field of pixel sizes for a 2D image (e.g., panoramic image) collected from continuous scanning imagery system. For images collected using a scanning system, the position of the camera changes during the acquisition of the image. Thus, the spatial information of the camera may be determined in positional increments. The examples shown in FIGS. 5A-5E relate to dental panoramic radiograph, where panoramic x-ray images of the upper and lower jaw are collected. Dental panoramic radiography equipment may include a horizontal rotating arm that holds an x-ray source and a moving film arranged at opposed extremities. The patient's skull sits between the x-ray generator and the film. The X-ray source may be a rectangular collimated beam, and the height of the beam may cover the mandibles and the maxilla regions. The arm of the system may rotate around a center that shifts on a dedicated trajectory to maintain constant distance between the teeth to the film and to project the teeth arch as orthogonally as possible. An ideal movement may not be possible as the anatomy varies from person to person.

FIG. 5A shows an example simulation setup including simulated x-ray beams 501 and a virtual film 505 for acquiring a panoramic image of a virtual dental arch 503. To simulate the dental panoramic radiograph process, the parametric virtual film 505 is placed around the dental arch 503 as shown. The virtual film 505 can be shaped in a polynomial curve of certain degrees (e.g. second order or higher order polynomials) or other parametric forms. The scan of the dental arch using the simulated x-ray beams 501 is followed and the mesh point is projected onto the virtual film 505 to generate a virtual panoramic image.

Note that in practice it is almost impossible to project a dental arch perfectly orthogonally. In order to generate virtual panoramic dental images that match with real world x-ray images, aspects of the parametric virtual film may be adjusted. For example, the distance between the dental arch 503 and the virtual film 505, the curvature of the virtual film 505, and/or the directions of the simulated x-ray beams 501 during the virtual scan along the dental arch 503 may be adjusted. That is, the x-ray source and the film may both be simulated to generate more “realistic” x-ray renderings. As a result, the virtual x-ray beams 501 and virtual film 505 setup can vary from case to case.

Using the above parametric panoramic imaging simulation system, individual teeth in the 3D model can be registered to the identified crowns in the x-ray, resulting in an overlay between 3D model and x-ray as shown in the images of FIGS. 5B and 5C, which show the upper and lower 3D arch, respectively, as registered to the 2D radiograph image.

FIGS. 5D and 5E show scaled images of the upper and lower jaws, respectively, represented as pixel size fields and resulting from using the simulation registration setup of FIG. 5A. These pixel size fields indicate that the pixel sizes range from 0.090 mm to 0.162 mm, which indicates that a significant error would occur if pixel size were to be estimated using only a single pixel size for the entire image (e.g., FACC method). Note that in FIGS. 5D and 5E, the bars and pixel size scales indicated along with the color bars may only be relevant to the images in their original resolutions. Since the panoramic rendering images in these figures have been rescaled, the pixel size scale numbers showing along with the color bars are not actual representations of the pixel sizes in the image. For example, the pixel size range of 0.090 mm to 0.162 mm shown is valid if the corresponding image is viewed in its native resolution.

As with the single shot camera system described above with reference to FIGS. 4A-4D, the pixel size fields for the image collected using the continuous scanning imagery system can be used to interpolate/extrapolate to objects that are not in the 3D model, such as the dental roots. These extrapolations are likely to be far more accurate than if a single pixel size for the entire image were used (e.g., using FACC method).

The methods described herein may be used to register a voxelized cone beam computed tomography (CBCT) 3D model to a radiograph image in order to obtain a more accurate pixel size for dental roots. While the resolution of 3D renditions acquired using CBCT is increasing, most CBCT machines do not provide the resolution required to diagnose certain pathologies (e.g., carious lesions, apical lesions, etc.). However, where a CBCT does exist, the size of the teeth and the roots may be known. These segmented 3D teeth models can then be registered to corresponding a radiograph image (e.g., bitewing, periapical, and/or panoramic images) to provide a precise measurement of the pixel size in the radiograph image, allowing for a more accurate measurement of a pathology in the diagnosis.

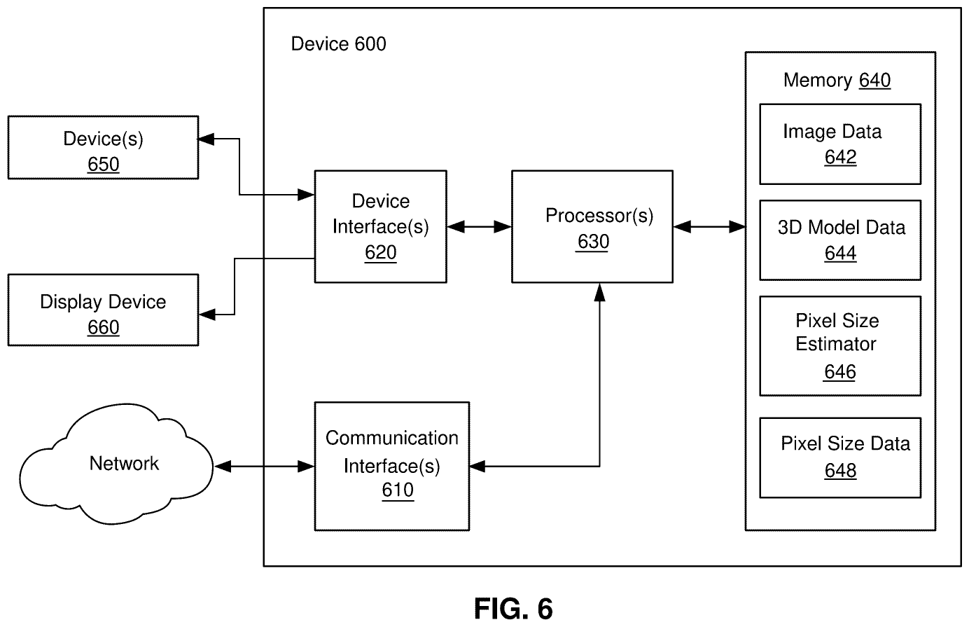

FIG. 6 shows a block diagram of an example system that includes a device 600 for implementing one or more of the methods described herein. Although described herein as a device, the functionality of the device 600 may be performed by any feasible apparatus, system, or method. The device 600 may include one or more communication interfaces 610, one or more device interfaces 620, one or more processors 630, and memory 640. In some examples, the device 600 may be configured to analyze images (e.g., dental images) and generate output resulting from the analysis. In some examples, the device 600 is configured to track the progress of a patient's dental treatment and/or evaluate a patient's teeth to determine whether a dental treatment should be performed.

The communication interface 610, which may be coupled to a network and to the processor 630, may transmit signals to and receive signals from other wired or wireless devices, including remote (e.g., cloud-based) storage devices, cameras, and/or displays. For example, the communication interface 610 may include wired (e.g., serial, ethernet, or the like) and/or wireless (Bluetooth, Wi-Fi, cellular, or the like) transceivers that may communicate with any other feasible device through any feasible network.

The device interface 620, which is coupled to the processor 630, may be used to interface with any feasible input and/or output device. For example, the device interface 620 may be coupled to an interface with one or more image capturing devices 650. Example image capturing devices may include optical cameras, x-ray devices, panoramic x-ray devices, portable cameras (e.g., phone cameras), and/or other imaging devices. In some examples, the device interface 620 may be coupled to an interface with a display device 660. Through the display device 660, the processor 630 may display images, feedback information, instructions, or the like.

In some examples, the image capturing device 650 and the display device 660 may be an integral part of the device 600. In other words, the image capturing device 650 and the display device 660 may share a common housing or enclosure. For example, the device 600 may be a cell phone, a tablet computer, or a laptop computer that includes at least these elements.

The processor(s) 630, which is also coupled to the memory 640, may be any one or more suitable processors capable of executing scripts or instructions of one or more software programs stored in the device 600 (such as within memory 640).

The memory 640 may include image data 642. The image data 642 may include one or more images (e.g., 2D images), for example, captured by the one or more imaging capturing devices 650. For example, the image data 642 may be obtained through the communication interface 610 and stored within the memory 640. The image data 642 may include dental images, optical images, x-ray images, panoramic images, video images, video frames, composite images formed from two or more source images, and the like. The image data 642 may include segmented data, in which boundaries of objects (e.g., teeth and/or gums) are identified and labeled (e.g., on a pixel-by-pixel basis). In some examples, the processor 630 is configured to segment an unsegmented image.

The memory 640 may include a non-transitory computer-readable storage medium (e.g., one or more nonvolatile memory elements, such as EPROM, EEPROM, Flash memory, a hard drive, etc.).

The memory 640 may include 3D model data 644. The 3D model data 644 may include one or more 3D models each represented as a mesh. For example, the 3D model data 644 may include a series of 3D models represented as a series of meshes corresponding to different stages of a treatment plan for a patient. The 3D model(s) may be segmented such that boundaries of objects (e.g., teeth and/or gums) are identified and labeled. In some examples, the 3D models are imported (e.g., via the communication interface 610) as pre-segmented meshes. In other examples, the processor 630 is configured to generate the 3D model(s). For example, the processor 630 may be configured to generate mesh(es) from 3D image data (e.g., from a scan of a patient's teeth). Alternatively or additionally, the processor 630 may be configured to generate a treatment plan and generate 3D models (e.g., meshes) based on the treatment plan.

The processor 630 may be configured to execute a pixel size estimator module 646 stored on the memory 640 to estimate pixel sizes of one or more images. The pixel size data 648 generated by the pixel size estimator module 646 may also be stored in memory 640. The pixel size data 648 may include different pixel sizes for different regions of an image, such as on a per-object basis (e.g., per-tooth basis) and/or an array of pixel sizes as a field across the image. In some cases, the pixel size data 648 includes a scaled image indicating pixel sizes at different locations of the image (e.g., FIGS. 4D, 5D and 5E).

In general, the methods and apparatuses described herein may allow for faster and more accurate measurements from an unscaled 2D image of a patient's dentition (e.g., teeth gingiva, tongue, etc.), even images taken by the patient with the patient's phone or other camera.

Also described herein are methods and apparatuses that may enhance the accuracy of measurements taken from one or more 2D images of a patient's dentition, particularly in cases in which the camera taking the 2D image is at an angle relative to the region in the 2D image being measured, or for regions of the 2D image for which pixel size measurements have not been estimated. In general, larger angles between the camera taking the 2D image and the region(s) being measured in the 2D image, e.g., along a line or curve, may result in the less accurate distance measurements, which may be corrected by taking additional pixel size scaling estimates. Alternatively, described herein are methods and apparatuses that may determine and apply a ratio of a distance measurement from the 3D digital model and a distance measurement from the 2D image, which may be referred to equivalently as a world to camera ratio or a correction ratio. This technique may be used to determine more accurate measurements for pixel size scaling, and may also be used to more accurately estimate distances for regions for which accurate pixel size scaling has not been performed, including regions such as gingiva and the palate, which may be difficult to determine accurate pixel size scaling, either because these regions may not be fully defined in the 3D model, may not be readily aligned with between the 2D image and the 3D model, and/or because it may be difficult to otherwise identify distinct and corresponding points.

A world to camera ratio (correction ratio) may correct for any skewing of perspective that may result when taking the 2D image. In general, the world to camera ratio is estimated for a 2D image by taking a ratio of a distance from the 3D digital model (the “world space”) and a distance for a corresponding region from the 2D image (the “camera space”) determined from a projection of the 3D digital model onto the 2D image. The distance from the 3D image may be directly measured, and the corresponding distance in the 2D image may be determined by multiplying the pixel size scaling for the region of the 2D image being measured by the distance (in pixels) for the corresponding region. The ratio of these distances between the corresponding points in the 2D image and the 3D model is a ratio of the measurement of points in the “world space” of the 3D model and the “camera space” of the 2D image. The pixel size scaling estimate may be determined using the camera angle of the camera relative to the region of the object (e.g., teeth, gingiva, palate, etc.) to determine a projected length of the object in the 2D (camera) image from the 3D (world) model, and dividing this projected length by the number of pixels in the length of the object from the 2D image.

The 3D model is generated from intraoral scan data, and may be considered as the “world space” from which clinically relevant measurements may be taken. The 2D image is typically generated from a single perspective, which depends on the distance and angle between the subject's mouth (e.g., teeth) and the camera taking the image. The resulting 2D image may be referred to as “camera space,” which is the space where the camera project's the subject's jaws to the image. The camera roll, pitch and yaw angles may each cause errors (“skew”) in measurements when these measurements are made in the camera space, and in some cases this skew may exceed a desired error tolerance, even at relatively small amounts of skew. Additionally, the surfaces of features in the subject's mouth (e.g., teeth, gingiva) that are being imaged are not all planar with a camera perspective. For example, the subject's teeth may be flared outward from the gingival line (e.g., with the crowns of anterior teeth flared anteriorly toward the camera when the camera is taking an anterior image). And additionally, various features within the subject's mouth can vary in their orientations. For example, from a given perspective, a first tooth may be oriented to have a first angle with respect to a plane corresponding to the perspective and a second tooth may be oriented to have a second angle with respect to the plane. As such, for any given perspective, there may be a plurality of different skews for different surfaces and features depicted.

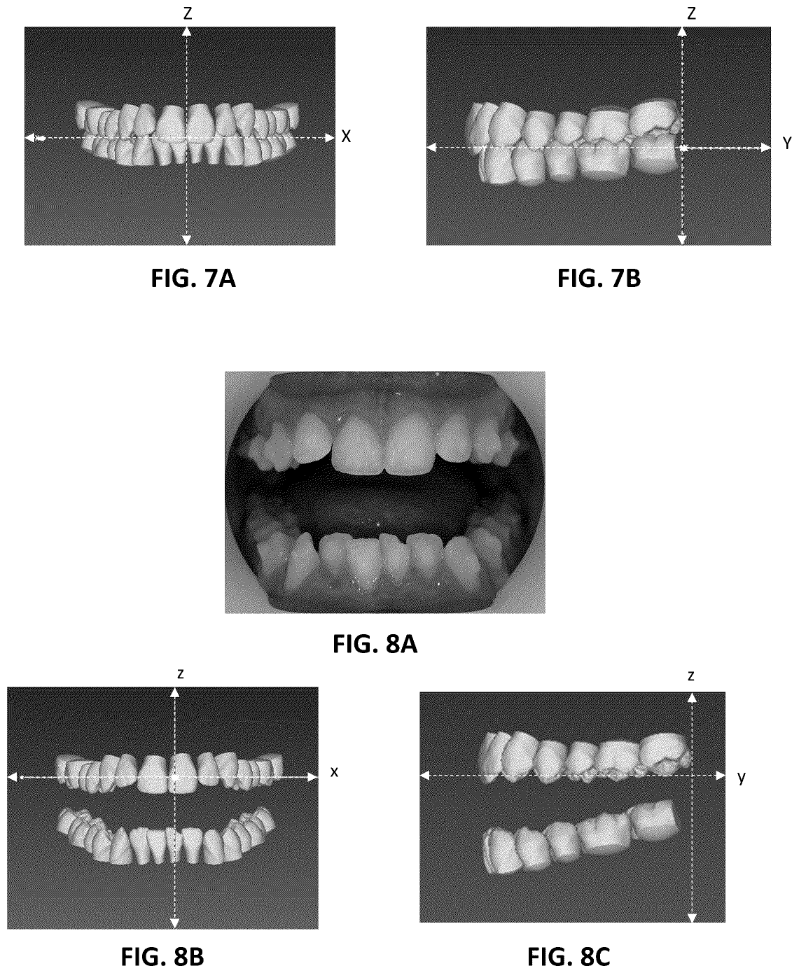

For example, FIGS. 7A and 7B illustrate an example of a pair of jaws in the world space. FIG. 7A shows a front view and FIG. 7B shows a side (buccal) view of a 3D model generated from an intraoral scan. The images shown in FIGS. 7A and 7B provide ground truth measurements which may be calculated in the coordinate system of the 3D model. FIG. 8A shows a 2D image of a subject's jaws, and FIGS. 8B-8C illustrate models of the upper and lower jaws shown in the 2D image of FIG. 8A. The upper and lower jaws are open in FIGS. 8B and 8C, as compared to FIGS. 7A and 7B, where the jaws are closed. As shown, this leads to changes in the upper and lower jaw orientation with respect to what can be expected to appear in an image plane. FIGS. 8B and 8C show views of a 3D model of the subject's teeth with the jaws in approximately the same orientation as shown in the 2D image of FIG. 8A. In FIGS. 8B and 8C, simulated camera planes (e.g., the zx plane and the zy planes, respectively) are shown. In this example, it may be useful to understand the angles between the dentition with respect to the camera, as well as the angle of the surface of the dentition with respect to each other.

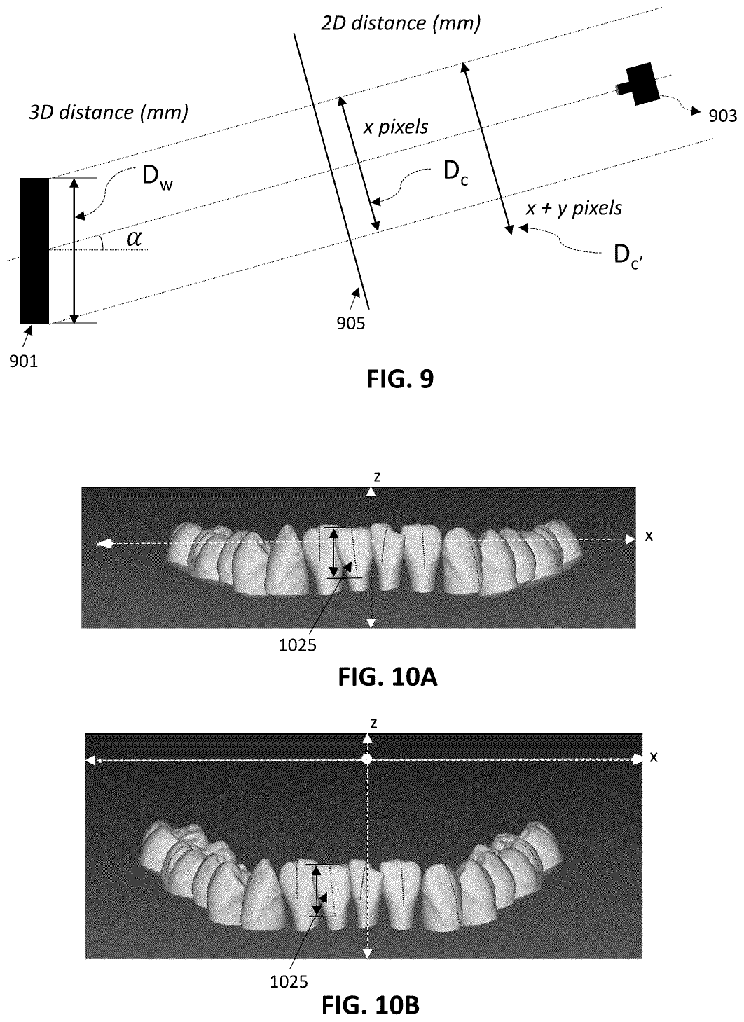

The skew in measurements resulting from the difference between the world space and the camera space is illustrated schematically in FIG. 9, which shows an object 901 (e.g., tooth or portion of a tooth, gingiva, etc.), as well as a position of a camera 903 relative to the object. The distance corresponding to the object may be measured in the world space (D_{w}), such as (but not limited to) a height of the object in the world space (H_{w}) by measuring between points in a 3D model generated from an intraoral scanner. FIG. 9 also shows the image plane 905 for the camera when an image of the object is taken by the camera at the illustrated camera position and orientation. The image plane is a plane that corresponds to a theoretical surface of the camera's focal plane, creating a corresponding image. From this image plane, the distance (D_{c}) between corresponding points on the 2D image may be measured, e.g., the height (H_{c}) of the object in the camera space. As illustrated, the height of the object in the camera space may not be the actual object height, since the camera is capturing what it sees on the image plane and the image plane is different from the plane of the object as it sits in the real world. In general, any distance on the object may be measured, including but not limited to a height measurement (e.g., not limited to a vertical height). Thus, there will necessarily be a difference between the measurement of the distance (e.g., height or other dimension) of the actual object in world space (D_{w}) and the measurement of the distance (e.g., height or other corresponding dimension) in the camera space (D_{c}). Even after accounting for distance in calculating pixel size as described elsewhere herein, the angle α of the camera relative to a surface of the object that is being imaged may result in a skew of the image dimensions that are captured by the camera. For example, as shown in FIG. 9, the angle of the camera relative to the surface of the object (α) may result in a height in the image, H_{c}, that is smaller than a height of the corresponding length in the world, H_{w} (e.g., an object that may be 10 mm in height may be measured as being 8 mm in height in a photo that is based on the image plane). In the simplified two-dimensional illustration of the concept in FIG. 9, there is a simple geometric relationship between the distance measured from the camera space (De) and the distance measured in the world space (D_{w}):

$${D}_{w} = {D}_{c} \times \frac{1}{cos ( α )}$$

This equation can be generically expressed for 3D space as D_{w}=D_{c}* ratio, where the “ratio” is a coefficient that depends on the orientation of the camera with respect to the object being measured. This correction ratio is the ratio of the world space to the camera space, and may account for the angle α, distance between the image plane and the object, and any other suitable factors. In the case where this distance is a height measurement, D_{w} and De may be referred to as H_{w} and He. Thus, the accuracy of the measurement of the object may be increased by determining an estimate of this ratio. In general, his may be done by identifying reference points (e.g., endpoints of a region to be measured) in both the 2D image and the 3D model, and measure the distance between these two reference points in the 3D model (e.g., the ‘world space’ measurement), e.g., D_{w}. The distance between the corresponding points in the camera space, D_{c}, may be determined based on the projection of D_{w} onto the image plane, using the geometric relationship between the camera and the region of the object being measured (e.g., the camera angle). For example, in simplified example shown in FIG. 9, the distance (D_{c}) is equal to the projection of D_{w} into the image plane by scaling D_{w} by the inverse of the cosine of the camera angle (α). Other geometric relationships may be used to determine the distance De corresponding to the projection of D_{w} into the camera plane, particularly in three dimensions. The camera position information (e.g., camera angle, camera distance, etc.) for any 2D image may be determined from the 3D model. For example, when aligning the 3D digital model to the 2D image, the camera orientation (camera angle) and distance may be estimated. In some cases camera position information may be determined from an actual or synthetic image that matches the 2D image.

The pixel size scaling when applying (or in some cases, determining) the world to camera ratio may be estimated as the projection of distance D_{w} in the image plane (D_{c}, which may be determined using the geometric relationship between the camera and the object, as described above), divided by the number of pixels along this distance (D_{c}) in the image plane. Thus, this type of image size scaling may depend upon the camera angle relative to the region being measured. Furthermore, this type of pixel size scaling is an average pixel size scaling along the distance De.

If the average pixel size scaling relative to the image plane is already known, the distance D_{c} may be determined by multiplying the number of pixels along the distance being measured from the 2D image by the average pixel size scaling.

The world to camera ratio may be estimated from the distance (e.g., length) of the object in the world (e.g., the 3D digital model) and the length of the object in the camera (2D) image, e.g., D_{w}/D_{c}. This ratio, along with the pixel size scaling, can then be used to map other distance measurements from the 2D image to the actual size measurements in the world space. These estimated distances will be particularly accurate when measured in line with the endpoints of the original object.

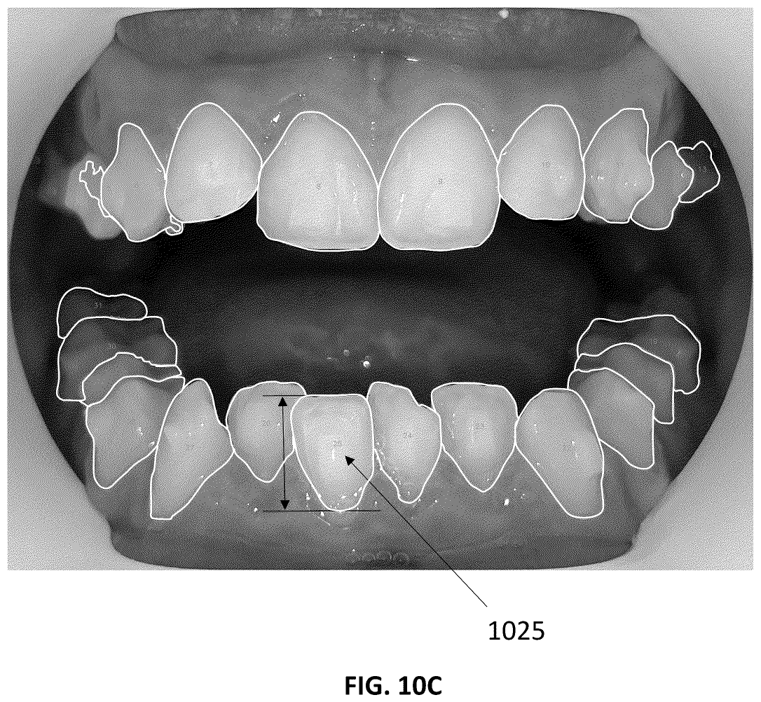

For example, FIGS. 10A-10C illustrate an example of measuring the height of tooth 1025 in both the world space (FIG. 10A) and from the camera space (FIG. 10B). FIG. 10C shows an example of a 2D image showing tooth 1025. In FIG. 10C the image has been segmented to identify (by outline) the individual teeth. In FIG. 10A reference points may be taken as endpoints from a top (incisal edge) and bottom (gingival edge) of tooth 1025, and the distance between them measured from the 3D model. The distance between the same two points may be measured as the number of pixels between the corresponding points in the 2D image (FIG. 10C). The pixel size scaling (e.g., average pixel size scaling) may be estimated as described above, e.g., estimating a distance of a projection of the object from the 3D model into the 2D image (camera plane) based on the actual distance from the 3D digital model and a geometric relationship of the camera relative to the object (e.g., camera angle), as shown in FIG. 10B.

The world to camera ratio and the average pixel size scaling may be used to determine a distance of a new region in the 2D image. Returning to the simplified example shown in FIG. 9, the distance of a second region D_{c}′ can be determined from just the 2D image, without further reference to the 3D model, by measuring the number of pixels (x+y) spanning the distance, D_{c}′, and multiplying by the average pixel size scaling. This distance may be corrected by multiplying by the world to camera ratio.

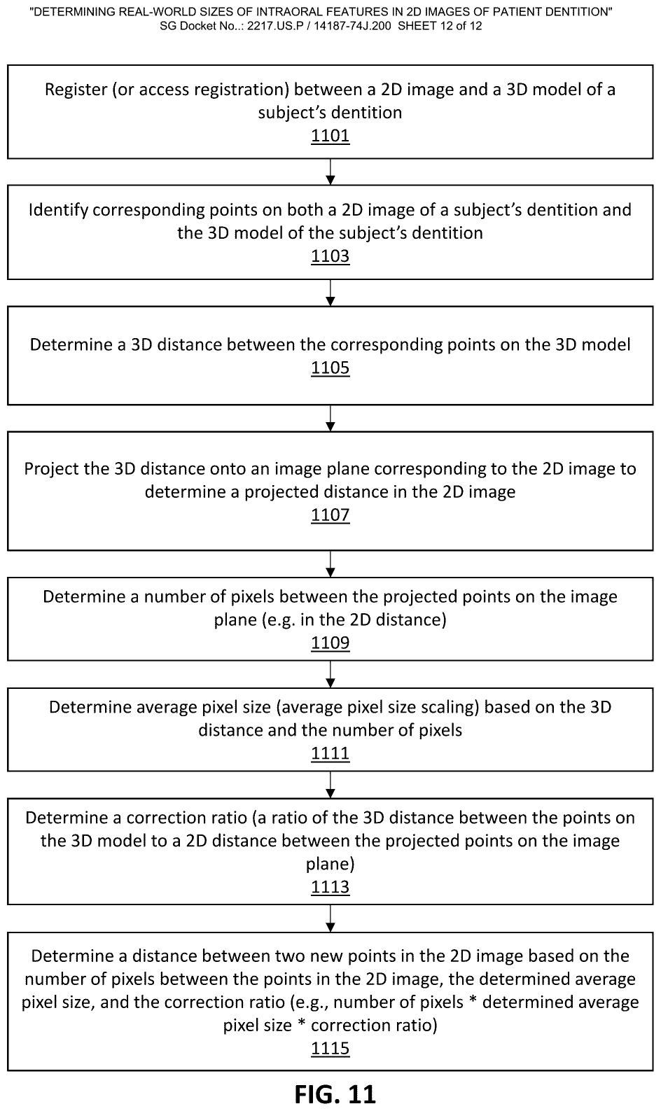

FIG. 11 shows an example of a method for determining distance measurements from a 2D image that are more accurately scaled using this technique. For example, in this method the 2D image of a subject's teeth may first be registered with the 3D model of the teeth derived from an intraoral scan of the same subject's teeth 1101, as described above. Registration may include determining the camera position relative to a region of the patient's dentition (e.g., teeth), such as determining an approximate camera angle of the 2D image relative to the patient's teeth. A corresponding two or more points on both the 2D image and the 3D model of the subject's dentition may then be identified 1103. Any two points may be used. In some cases the points may be approximately in-line with the distances to be measured, such as the FACC, interproximal widths, tooth widths, gingival depth, overbite distance, etc.

As mentioned above, two or more points may include a pair of points, three points, four points, five points, or more. The two or more points may define a line segment, a line, a curved line, a polygon, etc. The distance between the two or more points in the 3D model may be measured from the 3D model 1105 (in distance units, e.g., millimeters, micrometers). This distance determined in the 3D model will be referred to herein as the “3D distance.” The 3D distance may then be projected onto the 2D image using the camera position (e.g., camera angle) relative to the object (line segment, line, etc.) defined by the two or more points 1107. The resulting projected distance in the 2D image may be referred to as the 2D distance.

The number of pixels between the distance in the 2D image corresponding two or more points in the 2D image, e.g., the number of pixels in the 2D distance, may be measured from the 2D image 1109. An average pixel size scaling may be determined by diving the 2D distance by the number of pixels in the 2D image corresponding to the 2D distance 1111.

The 3D distance and the 2D distance may then be used to determine the world-to-camera ratio (correction ratio), by dividing the 3D distance by the 2D distance 1113. This world to camera ratio may be used to more accurately determine distances for regions outside of initial estimated region in the 2D image, even regions that are outside of the teeth, such as the gingiva, palate, etc. The average pixel size scaling and the correction ratio may be used to more accurately determine one or more distance from just the 2D image 1115. For example, one or more new distances may be measured from the 2D image and corrected using the correction ratio by measuring the number of pixels along the distance from the 2D image and multiplying the number of pixels by the average pixel size scaling determined as described above. This distance may then be corrected by multiplying by the correction ratio determined as mentioned above 1115.

The methods and apparatuses described herein may also be used to assist in tracking progress over time using 2D images, reducing the need for 3D scans. For example, these methods and apparatuses may be used to track the progress of movements (e.g., translations and/or rotations) of one or more features over time due to treatments, stopping treatments, or otherwise. For example, an angle of a feature (e.g., tooth) that is being moved in a dental treatment.

In general, these methods, including the methods of using a ratio of world to camera distances as described above, may be implemented as a module or set of modules that may access or receive the pixel size scaling for the 2D image of the subject's dentition. In some cases the method may include generating a scaled version of the 2D image by scaling the 2D image after registering the 2D image with the 3D model and determining a pixel size scaling for pixels of the 2D image using the scaled 3D model.

The corresponding points between the 2D image and 3D model may be identified using the registered 2D image/3D model. For example, identifying the corresponding two or more points on both the 2D image and the 3D model may include identifying a first two or more points on the 3D model and using the registration of the 2D image and the 3D model to identify a second two or more points on the 2D image corresponding to the first two or more points on the 3D model. These corresponding points may be identified automatically, manually or semi-automatically. For example, a user interface may be used to display either or both the 2D image and the 3D model and the user may select points from either the 2D image or the 3D model; or the apparatus may suggest points that the user may move. Once identified from, e.g., the 2D image, the corresponding points may be identified on the registered 3D model, and the ratio estimated as described above. The points used to estimate the ratio may be selected automatically or semi-automatically (e.g., suggested and allowed to be modified) based on the measurements to be made. For example, when FACC measurements are to be made, the points used to determine the ratio may be selected in-line with the direction of the FACC from the 2D image. In some cases the ratio may be determined entirely automatically, and the points may be selected automatically without requiring user interface input and/or display. The same or a different user interface may be used to allow the user to select points for measurement from the 2D image. For example, when estimating a distance between two or more additional points on the 2D image, the two or more additional points may be in-line with the corresponding two or more points on the 2D image.

Distances along a region or surface of a tooth may be estimated by dividing the surface up into line segments and using the methods described herein to measure the individual line segment distances, which may then be added up to get the total distance. For example, the method may include estimating the distance of a region from the 2D image by dividing the distance into a plurality of segments, and summing an estimated distance for each segment. The estimated distance for each segment may be calculated using the pixel size scaling for the 2D image, the number of pixels extending along each segment, and the ratio of the distance between the corresponding two or more points on the 3D model and the distance between the corresponding two or more points on the 2D image, as described above.

These methods may be applied to correct for skew between the world view and the camera view for any 2D image for which a 3D model may be registered. For example, these methods may be applied to estimate an overbite distance. In some cases the 2D image may include additional structures, such as a dental appliance, orthodontic attachments, restorations, etc., and measurements of these additional structures or relative to these additional structures may be made using these techniques. For example, the techniques described herein may be used to determine a spacing between a dental apparatus (e.g., aligner, retainer, palatal expander, etc.) and the subject's dentition from a 2D image.

In some cases, these methods and apparatuses may be used to estimate or determine distances or sizes of any feature in the 2D image, not limited to teeth. Although this disclosure focuses on examples characterizing teeth, any other suitable features of a subject that can be captured in 2D images may be characterized using the methods and systems described herein. For example, these methods may be used to estimate and/or monitor gingival recession from a 2D image. In these examples, it may be the case that the 3D model does not include information about the gingiva such as the location and geometry of gingival edges (or such models may include only incomplete or out-of-date information about the gingiva). However, a 2D image (e.g., an image subsequently taken by the patient or doctor) may include the gingiva. In these cases, there may be no corresponding points between the 3D model and the 2D image that can be used to come up with an approximate real-world distance. The methods and systems disclosed herein may be used in such cases to provide such an approximation, once average pixel size scaling and correction ratios are determined for an adjacent region (e.g., a tooth) based on the methods disclosed herein (e.g., registration of the 2D image and the 3D model, determining distances in the 3D model and 2D image for corresponding sets of points, determining average pixel size scaling, determining a correction ratio), the real-world distance of gingiva may be determined from the 2D image. As an example, a number of pixels between two points in a gingival portion may be determined, and this may be multiplied by average pixel size scaling and by the correction ratio that was determined for an adjacent region.

In some embodiments, the disclosed methods and systems may be used to estimate and/or track palatal dimensions. In the case of a patient undergoing a palatal expansion treatment, the patient's palate and/or teeth may be imaged and monitored. This may involve monitoring particular palatal features (e.g., palatal vault height, palatal arch width, palate shape, contours of the palatine rugae), gingiva, and/or teeth (e.g., distance between two opposing molars of the maxilla). For example, a patient may regularly take 2D photos using a smartphone or other camera device showing an occlusal view of the patient's maxilla. The methods and systems disclosed herein may be used to determine pixel sizes of different regions on the 2D photos, and the determined pixel sizes may be used to determine locations, orientations, and/or geometries of different intraoral features (e.g., palatal features, teeth, gingiva). This information may then be used to determine the treatment progress.

The methods and apparatuses described herein may output the measured distances as part of an image (e.g., display screen), as part of a report. These measured distances may be stored, transmit and/or displayed. The ratio and/or pixel size scaling information may be stored, transmitted and/or displayed, including displayed on a user interface.

The methods described herein to convert between one camera space and another camera space, e.g., allowing more direct comparison between two or more 2D images. For example, an overbite measurement may be made by determining the lower tooth visible ratio from a closed bite photo then mapped to open bite photo. In this example, upper and lower tooth heights in an open bite camera space may be converted to a closed bite camera space, so that all mapping-related computations may be performed in the closed bite camera space. For example, a length measurement made in the camera space of the second image (e.g., measured from an open bite image) may be determined from an image taken in a first camera space (e.g., a closed bit image) by multiplying the length measured from the image in the first camera space by a ratio of the ratios of the world to camera ratio for the first camera space and the second camera space.

As mentioned above, these methods and apparatuses provide a technical advantage over currently practiced methods and apparatuses for analyzing dental features such a teeth, jaws, gingiva, palate, etc., as they permit more accurate and high-resolution analysis of these features (at sub-millimeter scales) using otherwise uncalibrated 2D images that may be taken by the patient, clinician or technician even using a simple imaging device, such as the camera on a phone, tablet, etc. The techniques described herein, as embodied by these methods and apparatuses, may be particularly useful for estimating distances along or within a region and/or path in which pixel size is not expected to change significantly, such as a path in which the camera angle and/or positional distance from the camera is relatively constant. In practice, this may be performed more quickly and may require less computing power and/or fewer resources to achieve comparable results using more traditional techniques, which may require multiple intraoral scans (and/or corresponding 3D digital models), and/or may require multiple comparisons between a 3D digital model to accurately estimate distances. In contrast, the methods and apparatuses described herein may allow a plurality of distance measurements to be performed at selected locations (including forming an array of pixel size scaling estimates). In some cases, the methods described herein may associate pixel information with a 2D image so that a computing device may quickly and accurately determine distance between two or more points of the 2D image using a single pixel size scaling estimate or an array of pixel size scaling estimates, even for regions outside of the regions for which pixel size scaling was performed.

These methods and apparatuses may also permit the local, and therefore potentially faster and less resource intensive techniques for measuring and analyzing 2D image of a patient's dentition, for example, in a case where a first, e.g., local, computing device (e.g., a doctor's PC, a phone, etc.) includes one or more 2D images, and the 3D model, which may be derived from an intraoral scan, is on a second computing device (e.g., a server or other remote processor), since pixel scaling information can be quickly and locally associated with the 2D images. Thus, the first (e.g., local) computing device can act on its own without having to query the second computing device multiple times.

Additionally, as described previously, the disclosed methods and apparatuses allow for determinations of real-world distances of features that appear in a 2D image but were not captured in an associated 3D model. For example, as described previously, gingival recession can be estimated/monitored accurately even in cases where the 3D model does not include any information about the gingiva's geometry and dimensions. Similarly, the disclosed methods and apparatuses would allow for determinations of features that may not have been completely captured in a 3D model (e.g., a tooth that may have been obscured during a scan, a tooth whose surface geometry was not fully captured). As such, the disclosed methods and apparatuses add new capabilities for estimating, diagnosing, and monitoring patients.

Any of the methods (including user interfaces) described herein may be implemented as software, hardware or firmware, and may be described as a non-transitory computer-readable storage medium storing a set of instructions capable of being executed by a processor (e.g., computer, tablet, smartphone, etc.), that when executed by the processor causes the processor to control perform any of the steps, including but not limited to: displaying, communicating with the user, analyzing, modifying parameters (including timing, frequency, intensity, etc.), determining, alerting, or the like. For example, any of the methods described herein may be performed, at least in part, by an apparatus including one or more processors having a memory storing a non-transitory computer-readable storage medium storing a set of instructions for the processes(s) of the method.

While various embodiments have been described and/or illustrated herein in the context of fully functional computing systems, one or more of these example embodiments may be distributed as a program product in a variety of forms, regardless of the particular type of computer-readable media used to actually carry out the distribution. The embodiments disclosed herein may also be implemented using software modules that perform certain tasks. These software modules may include script, batch, or other executable files that may be stored on a computer-readable storage medium or in a computing system. In some embodiments, these software modules may configure a computing system to perform one or more of the example embodiments disclosed herein.

As described herein, the computing devices and systems described and/or illustrated herein broadly represent any type or form of computing device or system capable of executing computer-readable instructions, such as those contained within the modules described herein. In their most basic configuration, these computing device(s) may each comprise at least one memory device and at least one physical processor.

The term “memory” or “memory device,” as used herein, generally represents any type or form of volatile or non-volatile storage device or medium capable of storing data and/or computer-readable instructions. In one example, a memory device may store, load, and/or maintain one or more of the modules described herein. Examples of memory devices comprise, without limitation, Random Access Memory (RAM), Read Only Memory (ROM), flash memory, Hard Disk Drives (HDDs), Solid-State Drives (SSDs), optical disk drives, caches, variations or combinations of one or more of the same, or any other suitable storage memory.

In addition, the term “processor” or “physical processor,” as used herein, generally refers to any type or form of hardware-implemented processing unit capable of interpreting and/or executing computer-readable instructions. In one example, a physical processor may access and/or modify one or more modules stored in the above-described memory device. Examples of physical processors comprise, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, or any other suitable physical processor.

Although illustrated as separate elements, the method steps described and/or illustrated herein may represent portions of a single application. In addition, in some embodiments one or more of these steps may represent or correspond to one or more software applications or programs that, when executed by a computing device, may cause the computing device to perform one or more tasks, such as the method step.

In addition, one or more of the devices described herein may transform data, physical devices, and/or representations of physical devices from one form to another. Additionally or alternatively, one or more of the modules recited herein may transform a processor, volatile memory, non-volatile memory, and/or any other portion of a physical computing device from one form of computing device to another form of computing device by executing on the computing device, storing data on the computing device, and/or otherwise interacting with the computing device.

The term “computer-readable medium,” as used herein, generally refers to any form of device, carrier, or medium capable of storing or carrying computer-readable instructions. Examples of computer-readable media comprise, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

A person of ordinary skill in the art will recognize that any process or method disclosed herein can be modified in many ways. The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed.

The various exemplary methods described and/or illustrated herein may also omit one or more of the steps described or illustrated herein or comprise additional steps in addition to those disclosed. Further, a step of any method as disclosed herein can be combined with any one or more steps of any other method as disclosed herein.

The processor as described herein can be configured to perform one or more steps of any method disclosed herein. Alternatively or in combination, the processor can be configured to combine one or more steps of one or more methods as disclosed herein.

When a feature or element is herein referred to as being “on” another feature or element, it can be directly on the other feature or element or intervening features and/or elements may also be present. In contrast, when a feature or element is referred to as being “directly on” another feature or element, there are no intervening features or elements present. It will also be understood that, when a feature or element is referred to as being “connected”, “attached” or “coupled” to another feature or element, it can be directly connected, attached or coupled to the other feature or element or intervening features or elements may be present. In contrast, when a feature or element is referred to as being “directly connected”, “directly attached” or “directly coupled” to another feature or element, there are no intervening features or elements present. Although described or shown with respect to one embodiment, the features and elements so described or shown can apply to other embodiments. It will also be appreciated by those of skill in the art that references to a structure or feature that is disposed “adjacent” another feature may have portions that overlap or underlie the adjacent feature.

Terminology used herein is for the purpose of describing particular embodiments only and is not intended to be limiting of the invention. For example, as used herein, the singular forms “a”, “an” and “the” are intended to include the plural forms as well, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof. As used herein, the term “and/or” includes any and all combinations of one or more of the associated listed items and may be abbreviated as “/”.

Spatially relative terms, such as “under”, “below”, “lower”, “over”, “upper” and the like, may be used herein for case of description to describe one element or feature's relationship to another element(s) or feature(s) as illustrated in the figures. It will be understood that the spatially relative terms are intended to encompass different orientations of the device in use or operation in addition to the orientation depicted in the figures. For example, if a device in the figures is inverted, elements described as “under” or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly. Similarly, the terms “upwardly”, “downwardly”, “vertical”, “horizontal” and the like are used herein for the purpose of explanation only unless specifically indicated otherwise.

Although the terms “first” and “second” may be used herein to describe various features/elements (including steps), these features/elements should not be limited by these terms, unless the context indicates otherwise. These terms may be used to distinguish one feature/element from another feature/element. Thus, a first feature/element discussed below could be termed a second feature/element, and similarly, a second feature/element discussed below could be termed a first feature/element without departing from the teachings of the present invention.

Throughout this specification and the claims which follow, unless the context requires otherwise, the word “comprise”, and variations such as “comprises” and “comprising” means various components can be co-jointly employed in the methods and articles (e.g., compositions and apparatuses including device and methods). For example, the term “comprising” will be understood to imply the inclusion of any stated elements or steps but not the exclusion of any other elements or steps.

In general, any of the apparatuses and methods described herein should be understood to be inclusive, but all or a sub-set of the components and/or steps may alternatively be exclusive, and may be expressed as “consisting of” or alternatively “consisting essentially of” the various components, steps, sub-components or sub-steps.

As used herein in the specification and claims, including as used in the examples and unless otherwise expressly specified, all numbers may be read as if prefaced by the word “about” or “approximately,” even if the term does not expressly appear. The phrase “about” or “approximately” may be used when describing magnitude and/or position to indicate that the value and/or position described is within a reasonable expected range of values and/or positions. For example, a numeric value may have a value that is +/−0.1% of the stated value (or range of values), +/−1% of the stated value (or range of values), +/−2% of the stated value (or range of values), +/−5% of the stated value (or range of values), +/−10% of the stated value (or range of values), etc. Any numerical values given herein should also be understood to include about or approximately that value, unless the context indicates otherwise. For example, if the value “10” is disclosed, then “about 10” is also disclosed. Any numerical range recited herein is intended to include all sub-ranges subsumed therein. It is also understood that when a value is disclosed that “less than or equal to” the value, “greater than or equal to the value” and possible ranges between values are also disclosed, as appropriately understood by the skilled artisan. For example, if the value “X” is disclosed the “less than or equal to X” as well as “greater than or equal to X” (e.g., where X is a numerical value) is also disclosed. It is also understood that the throughout the application, data is provided in a number of different formats, and that this data, represents endpoints and starting points, and ranges for any combination of the data points. For example, if a particular data point “10” and a particular data point “15” are disclosed, it is understood that greater than, greater than or equal to, less than, less than or equal to, and equal to 10 and 15 are considered disclosed as well as between 10 and 15. It is also understood that each unit between two particular units are also disclosed. For example, if 10 and 15 are disclosed, then 11, 12, 13, and 14 are also disclosed.

Although various illustrative embodiments are described above, any of a number of changes may be made to various embodiments without departing from the scope of the invention as described by the claims. For example, the order in which various described method steps are performed may often be changed in alternative embodiments, and in other alternative embodiments one or more method steps may be skipped altogether. Optional features of various device and system embodiments may be included in some embodiments and not in others. Therefore, the foregoing description is provided primarily for exemplary purposes and should not be interpreted to limit the scope of the invention as it is set forth in the claims.

The examples and illustrations included herein show, by way of illustration and not of limitation, specific embodiments in which the subject matter may be practiced. As mentioned, other embodiments may be utilized and derived there from, such that structural and logical substitutions and changes may be made without departing from the scope of this disclosure. Such embodiments of the inventive subject matter may be referred to herein individually or collectively by the term “invention” merely for convenience and without intending to voluntarily limit the scope of this application to any single invention or inventive concept, if more than one is, in fact, disclosed. Thus, although specific embodiments have been illustrated and described herein, any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

1. A method comprising:
registering a two-dimensional (2D) image of a subject's dentition with a three-dimensional (3D) representation of the subject's dentition;
generating a pixel size scaling for the 2D image of the subject's dentition using the registered 3D representation, so that for each of one or more regions in the 2D image, the pixel size scaling comprises a scaling factor corresponding to each of the one or more regions indicating a size of the one or more pixels; and
outputting the pixel size scaling.

2. The method of claim 1, further wherein registering comprises determining virtual camera parameters of a virtual camera such that a virtual image of the 3D representation taken with the virtual camera parameters matches the 2D image, and wherein generating the pixel size scaling for the 2D image comprises estimating different pixel size scaling for the one or more regions in the 2D image based on the virtual camera parameters including a ratio of a distance from the camera to the pixel and a distance from the camera to the 2D image.

3. The method of claim 1, further wherein the 2D image of the subject's dentition is segmented to identify individual teeth corresponding to the one or more regions within the 2D image.

4. The method of claim 1, further comprising determining a length of a region of the 2D image using the pixel size scaling.

5. The method of claim 4, wherein determining the length of the region of the 2D image using the pixel size scaling comprises calculating and outputting one or more of: an overbite distance, an underbite distance, a posterior open bite distance, an interproximal spacing, and a distance between a tooth and an aligner.

6-7. (canceled)

8. The method of claim 1, wherein generating the pixel size scaling for the 2D image of the subject's dentition comprises determining the scaling factor for each visible tooth in the 2D image.

9. The method of claim 8, wherein at least two of the visible teeth in the 2D image have different pixel sizes.

10. The method of claim 1, further comprising selecting the 3D representation from a plurality of treatment plan 3D representations, wherein the selected 3D representation corresponds to a stage of a dental treatment plan that approximates the configuration of the subject's dentition in the 2D image.

11. The method of claim 1, wherein registering comprises estimating a tooth shape based on a plurality of sample tooth shapes, and maximizing a fit of the estimated tooth shape with a corresponding tooth of the 2D image using principal component analysis (PCA).

12. The method of claim 1, wherein registering comprises using a dental kinematics simulation framework to simulate a virtual image that matches the 2D image.

13. The method of claim 1, wherein generating a pixel size scaling for the 2D image of the subject's dentition comprises, for each visible tooth, determining a distance between two points on the 3D model, and calculating a ratio of the distance over a number of pixels between corresponding points of the 2D image.

14. The method of claim 1, wherein the one or more regions in the 2D image each include a crown center location of a tooth in the 3D model.

15. The method of claim 1, wherein outputting the pixel size scaling comprises outputting a data structure representing different pixel sizes for the one or more regions of the 2D image.

16. A method comprising:
registering a two-dimensional (2D) image of a subject's dentition with a three-dimensional (3D) representation of the subject's dentition to determine virtual camera parameters of a virtual camera such that a virtual image of the 3D representation taken with the virtual camera parameters matches the 2D image;
generating a pixel size scaling for the 2D image of the subject's dentition using the registered 3D representation of the subject's dentition and the virtual camera parameters to estimate a scaling factor, in units of length per pixel, for pixels in the 2D image; and
determining a length of a region of the 2D image using the pixel size scaling.

17. The method of claim 16, wherein generating the pixel size scaling for the 2D image comprises determining a field of pixel sizes across the 2D image.

18. The method of claim 16, wherein the virtual camera parameters include a distance between the virtual camera and the 3D representation.

19. The method of claim 16, further comprising selecting the 3D representation from a plurality of treatment plan 3D representations, wherein the selected 3D representation corresponds to a stage of a dental treatment plan that approximates the configuration of the subject's dentition in the 2D image.

20. The method of claim 16, wherein registering comprises estimating a tooth shape based on a plurality of sample tooth shapes, and maximizing a fit of the estimated tooth shape with a corresponding tooth of the 2D image using principal component analysis (PCA).

21. The method of claim 16, wherein registering comprises using a dental kinematics simulation framework to simulate a virtual image that matches the 2D image.

22. The method of claim 16, wherein generating a pixel size scaling for the 2D image of the subject's dentition comprises, for each visible tooth, determining a distance between two points on the 3D model, and calculating a ratio of the distance over a number of pixels between corresponding points of the 2D image.

23. The method of claim 16, wherein generating a pixel size scaling for the 2D image of the subject's dentition using the registered 3D representation of the subject's dentition and the virtual camera parameters to estimate a scaling factor, comprises dividing a length of an image plane of the virtual camera by a number of pixels along the length of the image plane and, for each pixel in the 2D image, multiplying by a ratio of a distance from the virtual camera to the pixel and a distance from the camera to the 2D image.

24. The method of claim 16, wherein determining the length of the region of the 2D image using the pixel size scaling comprises calculating one or more of: an overbite distance, an underbite distance, a posterior open bite distance, an interproximal spacing, and a distance between a tooth and an aligner.

25. The method of claim 16, wherein the 2D image comprises one of: a visible light image, an x-ray image, a panoramic image, a video image, and a stitched image based on two or more individual images.

26. A method comprising:
registering a two-dimensional (2D) image of a subject's dentition with a three-dimensional (3D) representation of the subject's dentition, wherein the 3D representation is selected from a plurality of 3D representations to approximate the configuration of the subject's dentition in the 2D image, to identify an aligned orientation of the 3D representation, wherein the registering comprises identifying a virtual camera position relative to the patient's dentition in the 3D representation to match the subject's dentition in the 2D image, further wherein the 2D image is segmented to identify individual teeth within the 2D image;
generating a pixel size scaling for the 2D image of the subject's dentition using the aligned 3D representation, wherein generating the pixel size scaling for the 2D image comprises estimating a pixel size for each visible tooth in the 2D image based on the virtual camera position; and
outputting the pixel size scaling.

27-67. (canceled)
